(19) United States
(12) Patent Application Publication
(10) Pub. No.: US 2017/0147991 A1
(43) Pub. Date: May 25, 2017

(54) VEHICLE DAMAGE REPORT

(71) Applicant: CSI Holdings I LLC, St. Louis, MO (US)

(72) Inventors: René Franke, Muelheim (DE); Christian Röckers, Bochum (DE); Michael Reinhold Schulte, Dortmund (DE); Michael Brian Morrison, St. Louis, MO (US); James Powell Hastings, Charlotte, NC (US)

(21) Appl. No.: 15/201,330

(22) Filed: Jul. 1, 2016

Related U.S. Application Data
(60) Provisional application No. 62/258,717, filed on Nov. 23, 2015.

(51) Int. Cl. G06Q 10/00; G06Q 30/02; G06K 9/46; G01B 21/20; G06K 9/62; G06T 7/00; G07C 5/00; G01M 17/007

(52) U.S. Cl. CPC G06Q 10/20; G07C 5/006; G07C 5/008; G06Q 30/0283; G06Q 30/0278; G01M 17/007; G01B 21/20; G06K 9/6202; G06T 7/0004; G06K 9/46; G06K 9/6267; G06K 2209/15; G06T 2207/30248

(57) ABSTRACT

A vehicle damage report is constructed from a scan of vehicle surfaces. Objective information derived from the surface scan is augmented with other information from other sources, such as vehicle identification information or repair cost estimates that can be used to facilitate and administer a multi-party downstream repair process.

### RELATED APPLICATIONS

This application claims the benefit of U.S. Provisional Application No. 62/258,717 filed on Nov. 23, 2015, the entire contents of which is hereby incorporated by reference.

This application is related to the following commonly-owned U.S. patent applications each filed on even date herewith and each incorporated herein by reference in its entirety: Attorney Docket Number CSIH-0002-P01 entitled “Damage assessment and repair based on objective surface data,” Attorney Docket Number CSIH-0002-P02 entitled “Damage assessment and repair based on objective surface data,” and Attorney Docket Number CSIH-0002-P03 entitled “Vehicle transactions using objective vehicle data.”

### TECHNICAL FIELD

The present disclosure generally relates to damage evaluation and repair, and more specifically to devices, systems, and methods for objectively evaluating damage to an item and automating and streamlining multi-party repair procedures.

### BACKGROUND

In the case of damage to automobiles (e.g., from accidents, from weather events such as hailstorms and the like, from normal wear and tear, etc.), most identification and analysis of the damage is performed by human inspectors or appraisers. Typically, the inspectors will document any previous damage, perform quantifying steps such as counting and classifying current damaged areas (e.g., dents and scratches), and then calculate an insurance claim based on this information. Inspections are thus very subjective (i.e., based on the particular inspector or other factors such as the environment in which the damage is viewed), and prone to inconsistency and wide variations. Additionally, the inspection, appraisal and repair process involves numerous unrelated entities including estimators, insurers, parts suppliers, repair shops, rental agents, regulatory authorities, and of course, the vehicle owner. The result is a lengthy, complex and expensive process requiring participation and coordination of numerous entities.

There remains a need for improved devices, systems, and methods for damage assessment and repair.

### SUMMARY

A vehicle damage report is constructed from a scan of vehicle surfaces. Objective information derived from the surface scan is augmented with other information from other sources, such as vehicle identification information or repair cost estimates that can be used to facilitate and administer a multi-party downstream repair process.

A scanning system creates an objective damage assessment of an item such as an automotive vehicle that can be used in subsequent assessment, repair, audit, and insurance processes. In general, the scanning system may scan any relevant portions of an item, and then use data processing techniques to detect features (e.g., geometric variations, reflectivity variations, and the like) associated with damage. This general capability may be used to improve the objectivity of related activities such as estimating and repair, while also providing a useful data record that can serve as a basis for coordinating multi-party activities during an estimate and repair process.

A system for administering a damage assessment and repair process may include a scanning system configured to capture a pre-repair scan including a digital surface representation of a surface of an item and process the digital surface representation to distinguish a defect in the surface, and a remote resource coupled in a communicating relationship with the scanning system through a data network, the remote resource including a processor configured to administer a repair of the item by performing the steps of preparing an estimate for repairing the item based on the digital surface representation using one or more local cost estimating rules and at least one remote repair cost tool accessible through the data network, securing an approval of the estimate from a commercial repair entity responsible for repairing the item based on the digital surface representation and the estimate, and securing an approval of a repair based on the estimate from an owner of the item. The system may further include a user interface hosted by the remote resource and remotely accessible through the data network for administering the repair.

Implementations may include one or more of the following features. The scanning system may include a portable scanning system. The scanning system may capture at least one of a shape and local surface normal of the surface. The scanning system may capture three-dimensional surface data using at least one of optical techniques, mechanical techniques, and acoustic techniques. The remote resource may be configured to compare the pre-repair scan to a prior scan for the item to identify a potentially duplicative repair. The processor may be configured to obtain automatic approval of the estimate by a remote claim processing system. The processor may be configured to automatically determine whether the owner is entitled to a rental during repairs, and wherein the user interface includes an interface for the owner to schedule the rental during repairs. The processor may be configured to automatically process payment from an insurer for the repair upon verification that the repair is complete. The processor may be configured to schedule a visit to an adjuster for preparation of an insurance estimate of a cost for repairing the item. The processor may be configured to provide updates to the owner on the damage assessment and repair process through at least one of electronic mail, instant message, telephone voice message, and updating a webpage accessible by the owner. The one or more local cost estimating rules may include a rule for determining when the defect can be repaired using paintless dent repair. The one or more local cost estimating rules may include a rule for comparing a cost of paintless dent repair for a vehicle panel to a cost of replacing the vehicle panel obtained from the at least one remote repair cost tool. The one or more local cost estimating rules may include a rule for physical repair of a vehicle panel. The remote resource may be configured to schedule the repair approved by the owner using a repair facility approved by an insurer. The remote resource may be configured to verify the repair by securing a post-repair scan from a second scanning system and comparing the post-repair scan to at least one of the pre-repair scan and a prior scan of the item. The user interface may include an interface for manual approval of the estimate by an insurance professional. The user interface may include an interface for scheduling a repair for the owner. The user interface may include contact information for an insurer responsible for the repair. The user interface may include a chat interface for communicating with an insurer responsible for the repair. The user interface may include one or more of an interface for providing status updates to the owner on the damage assessment and repair process and an interface for the vehicle owner to upload data and images.

A system for administering a damage assessment and repair process for a hail-damaged vehicle may include a scanning system configured to capture a pre-repair scan including a digital surface representation of a surface of one or more panels of a vehicle and to distinguish hail damage in the surface, and a remote resource coupled in a communicating relationship with the scanning system through a data network, the remote resource including a processor configured to administer a repair of the item by performing the steps of preparing an estimate for repairing the hail damage to the vehicle using one or more local cost estimating rules and at least one remote repair cost tool accessible through the data network, securing an approval of the estimate from a commercial repair entity responsible for repairing the hail damage to the vehicle, and securing an approval of a repair based on the estimate from an owner of the vehicle. The system may further include a user interface hosted by the remote resource and remotely accessible through the data network for administering the repair.

Implementations may include one or more of the following features. The scanning system may include a portable scanning system. The system may further include a deployment system for identifying a location of a hail damage cluster and deploying the portable scanning system to the location. The scanning system may capture at least one of a shape and local surface normal of the surface. The scanning system may capture three-dimensional surface data using at least one of optical techniques, mechanical techniques, and acoustic techniques. The remote resource may be configured to compare the pre-repair scan to a prior scan for the item to identify a potentially duplicative repair. The processor may be configured to obtain automatic approval of the estimate by a remote claim processing system. The processor may be configured to automatically determine whether the owner is entitled to a rental during repairs, and wherein the user interface includes an interface for the owner to schedule the rental during repairs. The processor may be configured to automatically process payment from an insurer for the repair upon verification that the repair is complete. The processor may be configured to schedule a visit to an adjuster for preparation of an insurance estimate of a cost for repairing the item. The processor may be configured to provide updates to the owner on the damage assessment and repair process through at least one of electronic mail, instant message, telephone voice message, and updating a webpage accessible by the owner. The one or more local cost estimating rules may include a rule for determining when the defect can be repaired using paintless dent repair. The one or more local cost estimating rules may include a rule for comparing a cost of paintless dent repair for a vehicle panel to a cost of replacing the vehicle panel obtained from the at least one remote repair cost tool. The one or more local cost estimating rules may include a rule for physical repair of a vehicle panel. The remote resource may be configured to schedule the repair approved by the owner using a repair facility approved by an insurer. The remote resource may be configured to verify the repair by securing a post-repair scan from a second scanning system and comparing the post-repair scan to at least one of the pre-repair scan and a prior scan of the item. The user interface may include an interface for manual approval of the estimate by an insurance professional. The user interface may include an interface for scheduling a repair for the owner. The user interface may include a chat interface for communicating with an insurer responsible for the repair. The user interface may include an interface for providing status updates to the owner on the damage assessment and repair process.

A method may include obtaining a scan of a vehicle, the scan including a digital surface representation of a plurality of panels of a vehicle, analyzing the scan to detect defects in each one of the plurality of panels, creating a status report including an objective status of a physical state of the vehicle based on the scan, associating the status report with the vehicle, and performing a transaction with the vehicle based on the status report.

Implementations may include one or more of the following features. The transaction may include offering the vehicle for sale in a secondary market with the status report. The transaction may include insuring the vehicle, and further wherein an insurer requires the status report as a condition for insuring the vehicle. The scan may be obtained using a portable scanning system. The scan may capture at least one of a shape and local surface normal of a surface for each one of the plurality of panels. The scan may capture three-dimensional surface data using at least one of optical techniques, mechanical techniques, and acoustic techniques. The status report may include one or more of a vehicle mileage, a repair history, an accident history, and a visual inspection report.

A method may include receiving a returned vehicle at a conclusion of a vehicle lease, where the vehicle lease includes an allowance for normal wear and tear in a physical condition of a plurality of panels of the returned vehicle at the conclusion of the vehicle lease, obtaining a scan of the returned vehicle, the scan including a digital surface representation of the plurality of panels of the returned vehicle, analyzing the scan to detect defects in each one of the plurality of panels, thereby providing a status report including an objective status of a physical state of the returned vehicle, automatically identifying excess damage to the returned vehicle in the status report that exceeds the allowance for normal wear and tear, and adjusting a value of the returned vehicle under the vehicle lease according to the excess damage.

Implementations may include one or more of the following features. Adjusting the value of the returned vehicle may include issuing a repair bill. Adjusting the value of the returned vehicle may include issuing a repair requirement. The scan may be obtained using a portable scanning system. The scan may capture at least one of a shape and local surface normal of a surface for each one of the plurality of panels. The scan may capture three-dimensional surface data using at least one of optical techniques, mechanical techniques, and acoustic techniques. The status report may include one or more of a vehicle mileage, a repair history, an accident history, and a visual inspection report.

A computer program product for performing a vehicle transaction based on objective status information for the vehicle may include computer executable code embodied in a non-transitory computer readable medium that, when executing on one or more computing devices, performs the steps of obtaining a scan of a vehicle, the scan including a digital surface representation of a plurality of panels of a vehicle, analyzing the scan to detect defects in each one of the plurality of panels, creating a status report including an objective status of a physical state of the vehicle based on the scan, associating the status report with the vehicle, and performing a transaction with the vehicle based on the status report.

Implementations may include one or more of the following features. The transaction may include offering the vehicle for sale in a secondary market with the status report. The transaction may include insuring the vehicle, and further wherein an insurer requires the status report as a condition for insuring the vehicle. The status report may include one or more of a vehicle mileage, a repair history, an accident history, and a visual inspection report.

A computer program product for adjusting the value of a returned vehicle based on objective status information for the vehicle may include computer executable code embodied in a non-transitory computer readable medium that, when executing on one or more computing devices, performs the steps of receiving a returned vehicle at a conclusion of a vehicle lease, where the vehicle lease includes an allowance for normal wear and tear in a physical condition of a plurality of panels of the returned vehicle at the conclusion of the vehicle lease, obtaining a scan of the returned vehicle, the scan including a digital surface representation of the plurality of panels of the returned vehicle, analyzing the scan to detect defects in each one of the plurality of panels, thereby providing a status report including an objective status of a physical state of the returned vehicle, automatically identifying excess damage to the returned vehicle in the status report that exceeds the allowance for normal wear and tear, and adjusting a value of the returned vehicle under the vehicle lease according to the excess damage.

A method may include obtaining a scan of a vehicle, the scan including a digital surface representation of a panel of the vehicle, analyzing the scan to detect and to distinguish a defect in the panel, thereby providing an analysis including a location of the defect and a size of the defect, obtaining vehicle identification information for the vehicle including a vehicle identifier, an owner, and an insurer, verifying the owner and the insurer based on the vehicle identifier, combining the vehicle identification information, the scan, and the analysis into a damage report, and communicating the damage report to a remote claims processing resource over a data network.

Implementations may include one or more of the following features. The method may further include automatically selecting a repair method based on the scan. The method may further include automatically creating a number of suggested repair methods based on the scan, and presenting the number of suggested repair methods to a user. Analyzing the scan may include determining whether the defect can be repaired using paintless dent repair. Analyzing the scan may include estimating a cost to repair the defect using paintless dent repair. Analyzing the scan may include creating a repair estimate for the vehicle. The method may further include adding the repair estimate to the damage report, the repair estimate including an estimate of parts and labor required for a repair. Analyzing the scan may include estimating an impairment to vehicle value and including the impairment to vehicle value in the damage report. The defect may include hail damage. The method may further include obtaining an image of a license plate for the vehicle and comparing the license plate to the vehicle identifier. The method may further include creating a visualization of the panel that includes an image of the panel with a plurality of defects in the panel, the plurality of defects color coded according to one or more defect attributes. The one or more defect attributes may include at least one of a size, a severity, a cost, and a cause. The method may further include receiving an annotation from a technician, the annotation associated with a location within a coordinate system of the scan, and storing the annotation in the damage report. The method may further include providing interactive access to the damage report by the owner, the insurer, and at least one repair professional. The method may further include transmitting the damage report to a plurality of repair professionals over a data network and requesting responsive bids from the repair professionals. The method may further include comprising transmitting the damage report to a plurality of repair professionals over a data network and requesting acceptance of a repair based on an automatically generated repair estimate.

A computer program product comprising computer executable code embodied in a non-transitory computer-readable medium that, when executing on one or more computing devices, may perform the steps of obtaining a scan of a vehicle, the scan including a digital surface representation of a panel of the vehicle, analyzing the scan to detect and to distinguish a defect in the panel, thereby providing an analysis including a location of the defect and a size of the defect, obtaining vehicle identification information for the vehicle including a vehicle identifier, an owner, and an insurer, verifying the owner and the insurer based on the vehicle identifier, combining the vehicle identification information, the scan, and the analysis into a damage report, and communicating the damage report to a remote claims processing resource over a data network. The code may further perform the step of automatically selecting a repair method based on the scan. The code may further perform the step of automatically determining whether the defect can be repaired using paintless dent repair. Analyzing the scan may include creating a repair estimate for the vehicle.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 illustrates a system for vehicle damage evaluation and repair.

FIG. 2 is a flowchart of a method for vehicle damage evaluation and repair.

FIG. 3 illustrates a scanning system.

FIG. 4 illustrates a method for generating a vehicle damage report.

FIG. 5 illustrates a method for conducting vehicle transactions based on an objective vehicle assessment.

FIG. 6 illustrates a method for assessment of damage to a returned vehicle.

FIG. 7 illustrates a method for assessment of damage to a vehicle offered for sale.

FIG. 8 shows a user interface for a damage assessment and repair administration system.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods for damage evaluation and repair, e.g., in vehicles such as automobiles. Although the following description emphasizes devices, systems, and methods for detecting, identifying, and classifying damage in automobiles (and then further applying that information), the implementations may also or instead be used for other vehicles such as watercrafts, aircrafts, space crafts, buses, trolleys, trains, motorcycles, bicycles, snowmobiles, submersible vehicles, hovercrafts, trucks, mobile industrial equipment, scooters, personal transporters such as hoverboards and the like, and so forth. Further, the devices, systems, and methods described herein may be adapted for use for damage assessment and repair in objects other than vehicles, including without limitation, personal items (e.g., jewelry, toys, electronics, musical instruments, silverware, china, antiques, coins, collectibles, sports equipment, furniture, artwork, appliances, and so forth), structures (e.g., houses, buildings, sculptures, bridges, roads, pathways, and so forth), and the like. More generally, the devices, systems, and methods described herein may be adapted for use with any item that might be usefully scanned for purposes of valuation, damage assessment, repair, insurance claim handling, and so forth. In an implementation, anything that is capable of being scanned can be used in the various devices, systems, and methods discussed herein. Thus, unless explicitly stated to the contrary or otherwise clear from the context, the words “vehicle,” “automobile,” and the like shall include any of the aforementioned items.

Further, although the following description emphasizes devices, systems, and methods for damage assessment in vehicles (and then further applying damage information), the implementations may also or instead be used for obtaining a current state of a vehicle. This may be utilized for establishing a baseline, for pre-scanning purposes, for detecting damage after an accident or other event as described herein, for detecting the quality of a repair, for detecting mechanical flaws, for detecting cosmetic flaws, for detecting structural flaws, for detecting manufacturing flaws, and so forth. Thus, unless explicitly stated to the contrary or otherwise clear from the context, the term “damage” when used in the context of detection, identification, and classification, shall also or instead be referring to a state of the vehicle being assessed.

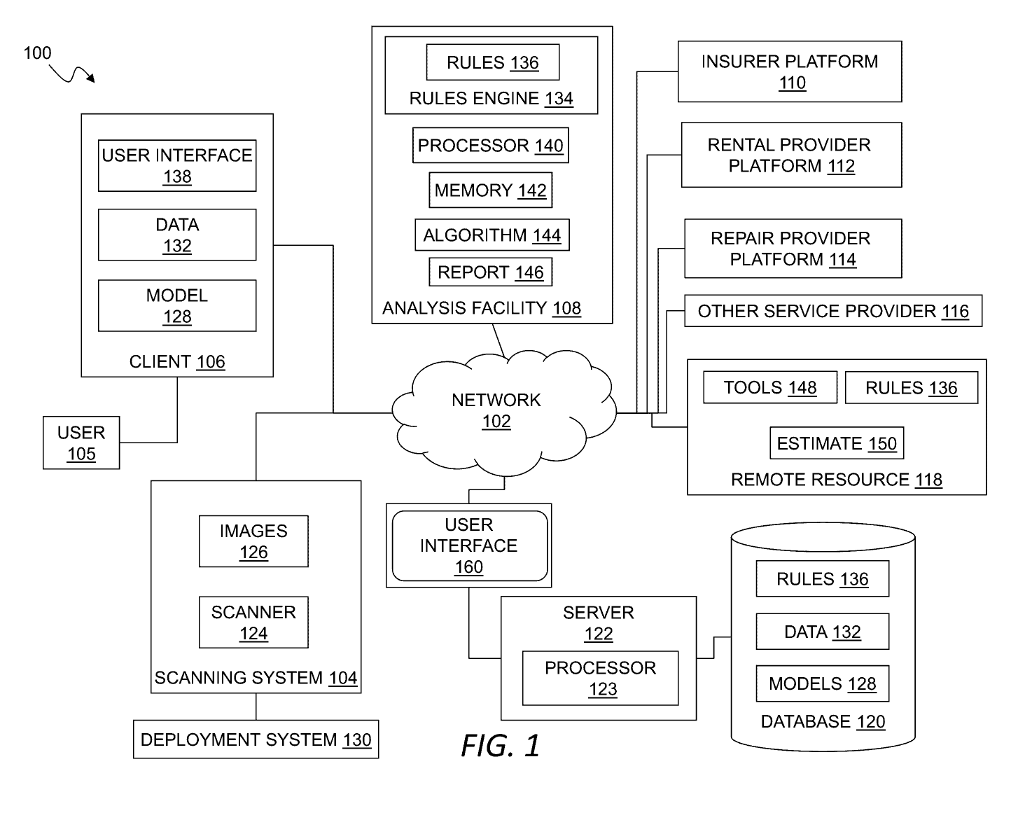

FIG. 1 illustrates a system for vehicle damage evaluation and repair. In general, the system 100 may be used for damage assessment or other general assessment of a state of an item such as a vehicle. The system 100 may provide a platform for scanning the item and performing an analysis based on the scan. A scan may cover any relevant surfaces or features of the item, and the system 100 may perform image analysis or any other suitable data processing techniques to identify geometric variations associated with damage. In the case of vehicles, the system 100 as described herein may be used to augment repair processes (e.g., estimating repairs or evaluating repairs), insurance processes (e.g., determining whether damage is covered by insurance, appraisals, coordination of repair and related services, and so on), rental and leasing processes (e.g., assessing damage to a vehicle upon its return to a fleet), vehicle sales processes (e.g., determining a value based on damage or otherwise on a state of the vehicle determined by the scan), and so forth.

As shown in the figure, the system 100 may include a network 102 interconnecting a plurality of entities (e.g., devices, systems, components, resources, facilities, and so on) in a communicating relationship. The entities may, for example, include a scanning system 104, any number of clients 106, an analysis facility 108, computing systems or infrastructure operated independently by a variety of service providers and the like (e.g., an insurer platform 110, a rental provider platform 112, a repair provider platform 114, and other service providers 116), a remote resource 118, a database 120, and a server 122.

The network 102 may include any data network(s) or internetwork(s) suitable for communicating data and control information among participants in the system 100. This may include public networks such as the Internet, private networks, and telecommunications networks such as the Public Switched Telephone Network or cellular networks using third generation cellular technology (e.g., 3G or IMT-2000), fourth generation cellular technology (e.g., 4G, LTE. MT-Advanced, E-UTRA, etc.) or WiMax-Advanced (IEEE 802.16m)) and/or other technologies, as well as any of a variety of corporate area, metropolitan area, campus or other local area networks or enterprise networks, along with any switches, routers, hubs, gateways, and the like that might be used to carry data among participants in the system 100. The network 102 may also include a combination of data networks, and need not be limited to a strictly public or private network.

The participants in the system 100 may each include network interfaces or the like for communication over the network 102. The data network 102 and the network interfaces of the participants may allow for real time data or near-real time synchronization of data across service provides so that, for example, an end user such as a vehicle owner or a repair professional can obtain accurate, actionable data about an insurance adjustment and repair process with little or no observable latency.

The scanning system 104 may include one or more components for image capture of an item such as an automobile or other vehicle. For example, the scanning system 104 may be configured to capture a pre-repair scan including a digital surface representation of a surface of the item (e.g., a panel of an automobile) and to distinguish a defect in the surface. The defect may be any as described herein, e.g., damage caused by a vehicular accident, hail damage, normal wear and tear, and so forth. The scanning system 104 may thus include a scanner 124 that is configured to produce images 126 or other data from an item being scanned, e.g., a vehicle. The images 126 may then be used to generate a model 128 or the like, e.g., for use and analysis by the scanning system 104 or other participant in the overall system 100.

The scanning system 104 may in general be a portable or mobile scanning system, and may capture surface information such as shape or local surface normal for use in dent detection. As generally described herein, the scanning system 104 may capture three-dimensional surface data using at least one of optical techniques, mechanical techniques, and acoustic techniques.

The scanning system 104 may capture one or more of a shape and a local surface normal of the surface of the item being scanned, e.g., a vehicle panel, or any other data or surface representation useful for objective damage assessment. The scanning system 104 may include a portable scanning system, such as a booth or the like that can be transported to a location and deployed temporarily for scanning, or a truck or other vehicle with a portable enclosure for receiving and scanning vehicles. A deployment system 130 may be used for identifying a location where the scanning system 104 is needed. For example, the deployment system 130 may identify a hail damage cluster based on incoming insurance claim requests, or based on weather monitoring or the like, and deploy the portable scanning system to the location.

The scanning system 104 may in general be any system suitable for capturing a digital surface representation of an item that can be used for objective damage assessment as contemplated herein. The scanning system 104 may, for example, include an optical measurement system, e.g., a customized optical measurement system, or a mobile optical measurement system for the surface inspection of objects being scanned (e.g., scanning automobiles for hail damage detection or other types of defect detection, or for an inspection at the close of a leasing or rental period, or any other processes needed to establish a baseline of the condition of a vehicle). The scanning system 104 may thus capture three-dimensional surface data of the item being scanned using optical techniques. In one aspect, the surface data may be a three-dimensional model of the surface. In another aspect, the surface data may encode surface deviation information indicative of possible damage. The scanning system 104 may also or instead capture three-dimensional surface data of the item being scanned using mechanical techniques, acoustic techniques, and the like.

The scanner 124 of the scanning system 104 may include a plurality of cameras or other image capturing or scanning devices, lasers or other projection devices, other illumination, and so forth. The scanner 124 may be included in a standalone structure such as a structure resembling a booth, a bay, a garage, or a drive-through facility, which may be integrated into the portable scanning system described herein.

The scanner 124 may be adapted for imaging on a reflective or specular surface. For example, the scanner 124 may include any of the scanners, imaging systems, or other devices, systems, and methods, described in German Pat. No. DE102010015566B4 entitled “Method and system for measurement of reflective surfaces,” Int'l Pub. No. WO/2005/031251 entitled “Optical method and device for determining the structure of a surface,” U.S. Pat. No. 7,532,333 entitled “Method and apparatus for determining the shape and the local surface normals of specular surfaces,” German Pat. App. No. DE102004033526A1 entitled “Analysis of at least partly reflecting surfaces involves varying relative orientation/position of object, pattern generation device and/or image receiver(s) for image reflected at surface, to obtain surface, especially geometry, information,” German Pat. No. DE102006012432B3 entitled “A method for detecting the surface shape of a part of the reflecting surface,” and German Pat. App. No. DE102006006876A1 entitled “Method of detecting the contour of a reflective surface using a virtual image of the reflective points.” The entire content of each of the aforementioned patents and publications is hereby incorporated by reference herein.

The scanner 124 may be configured for the field-capture of damage to a vehicle via mobile or stationary imaging, and comparison of images to other reference imagery. Additional scanners and data acquisition devices may also be used to augment the capture of useful vehicle information. Thus for example, the scanner 124 may also or instead include digital cameras, video cameras or any other scanning devices for obtaining surface information or sub-surface information, including scanning systems based on ultrasonic, acoustic, optical, magnetic, x-ray, radio frequency, or other scanning mediums, as well as combinations of the foregoing. All such scanners 124 and scanning technologies may be used alone or in combination to obtain information relevant to a vehicle assessment as contemplated herein.

It will also be understood that a scanner 124 as contemplated herein may include multiple scanners. Thus for example, some of the techniques described above are particularly advantageous for measuring surface normals of reflective surfaces (such as automobile panels) in order to determine shape and detect small magnitude defects such as hail dents or other impact damage from small objects. A scanner using these techniques may be helpful for locating and characterizing hail dents in a consistent, objective manner, particularly where the magnitude of a surface defect is small, but the rate of change in a surface normal at or near the center of the defect is substantial. This provides a significant advantage over other techniques that otherwise rely on inconsistent, subjective evaluations of difficult-to-identify surface defects by appraisers or other technicians, or other digital three-dimensional scanning techniques that may be suitable for capturing gross panel geometry but lack the sensitivity or resolution to capture small surface defects resulting from hail damage or other impact with small surfaces at a relatively high speed (e.g., sufficient to plastically deform the impacted surface). At the same time, linear dimensions (e.g., bumper-to-bumper length) may be important for evaluating internal damage from a collision or the like. This may be more usefully measured using laser range finding or other techniques better suited to single, precise measurements of distance or length. In another aspect, aggregate three-dimensional geometry may be useful, e.g., for automatically determining a vehicle type or detecting large-scale defects or damage such as a moderate or severe damage to portions of the vehicle, or misaligned panels, bumpers, etc. Where this type of damage is being evaluated, other types of three-dimensional scanning may be used, such as techniques using shape-from-motion, structured light, laser time-of-flight (e.g., Lidar and the like), computed tomography, and so forth. In another aspect, two-dimensional visual damage may be useful, e.g., for optical character recognition (“OCR”) (e.g., for capture of license plate information), for machine vision recognition of defects in paint or finish, or for two-dimensional capture of overall vehicle geometry. A useful scanning system, as contemplated herein, may integrate several or all of these different types of scanners in order to capture an objective, digital assessment of a vehicle for use in downstream processes of appraisal, damage assessment, repair verification, and so forth, and all such combinations are intended to fall within the scope of this disclosure.

The clients 106 may include any client devices suitable for use with the system 100 contemplated herein. This may include a computer with a web browser or other user interface 138 for access by a vehicle owner to monitor an assessment and repair process. This may also or instead include a computer used by a repair technician or estimator at a location where a scan is being performed. Or this may be a computer at a remote location where an administrator for the server 122 can log in to manage case assignments, review work progress, respond to customer inquiries, and so forth.

The clients 106 may also or instead include client devices, service provider devices, network devices, and any other computing devices or the like that might usefully connect to the network 102 for use in the various systems and methods contemplated herein. A client 106 may include a desktop computer, a laptop, a Personal Digital Assistant (PDA), a mobile phone, a smart phone, a tablet, a virtual reality device (e.g., headset, goggles, glasses, and the like), or any other mobile or fixed computing device. A client 106 may also or instead include a virtual device instantiated in a virtualization environment for use in the system 100. In embodiments, the term “client” may refer to a computer system that may source data, receive data, evaluate data, buffer data, or the like, such as a user's desktop computer. A client 106 may also or instead include an application loaded onto a computer platform. In another aspect, a client 106 may support an API connection or web connection (or any other form of connection) to remote resources such as a database 120 (e.g., a damage assessment costs database), an insurer platform 110 or insurance adjuster, a rental provider platform 112 or leasing companies, and so forth. The system 100 may also or instead support connections between adjusters, estimators, insurer platforms 110, parts databases, and so forth. These may be API connections configured to enable real time communications among entities, and correspondingly timely updates to participants or participant dashboards or other reporting interfaces. In another aspect, the server 122 may provide a hub for communications among these entities to broker communications and exchange of information in an orderly manner and support integrated reporting to various participants.

The client 106 may include a user interface 138. The user interface 138 may, for example, be a browser-based interface that is hosted by the remote resource 118, server 122 or any other participant in the system 100 and remotely accessible through the data network 102 for administering a repair, e.g., based on a scan, monitoring progress, reviewing scan results, and so forth. In this manner, the server 122 may provide a centralized point of contact among various other participating entities (e.g., a user 105, the insurer platform 110, the rental provider platform 112, the repair provider platform 114, other service providers 116, and so on). For example, the user interface 138 may include an interface for an owner of the item being scanned (e.g., a vehicle) to schedule a rental during repairs, e.g., from the rental provider platform 112. The user interface 138 may also or instead include an interface for manual approval of an estimate by an insurance professional, e.g., the insurer platform 110 shown in the figure. The user interface 138 may also or instead include an interface for scheduling a repair for the owner, for providing status updates to the owner on the damage assessment and repair process, or an interface for the vehicle owner to upload data (e.g., images and other data). The user interface 138 may also or instead include contact information for an insurer responsible for the repair or a chat interface for communicating with an insurer platform 110 of an insurance carrier responsible for a repair.

The user interface 138 may include a graphical user interface, a text or command line interface, a voice-controlled interface, and/or a gesture-based interface to interact with one or more of the data 132, the model 128, images 126, rules 136, and so forth. The user interface 138 may include a computer-aided design (CAD) program or other drawing program interface or similar tool or combination of tools that provides one or more drawing tools for the user 105 to interact with, manipulate, or edit drawings, data 132, models 128, and images 126 contained therein. The user interface 138 may be maintained by a locally executing application on the client 106 that receives data 132, images 126, rules 136, and models 128 from other participants of the system 100. In general, the user interface 138 may create a suitable display on the client 106 for user interaction. In other embodiments, the user interface 138 may be remotely served and presented on the client 106, such as where the server 122 includes a web server that provides information through one or more web pages or the like that can be displayed within a web browser or similar application executing on the client 106.

The analysis facility 108 may analyze data 132 received from a participant in the system 100, such as the scanning system 104 or the client 106. The analysis facility 108 may include a processor 140 and a memory 142 configured to apply algorithms 144 to perform the functions described herein. Specifically, the processor 140 may be configured to analyze data 132 and apply a set of rules 136 to perform any desired analysis function, such as processing scanner data, locating damage, creating repair estimates, and so forth. The memory 142 on the analysis facility 108 may store computer code for executing the rules engine 134, and the memory 142 may also store data 132.

The analysis facility 108 may, in cooperation with the scanning system 104, include software that captures images, combines the images, performs signal processing, and converts data retrieved therefrom to a representation of damage for a scanned item. The analysis facility 108 may generate a report 146. The report 146 may include data concerning damage to the scanned item, e.g., damage on a vehicle in the form of dents, scratches, chips (e.g., stone chips), and other surface damage. The data concerning damage may include information regarding the detection and classification of the damage, including without limitation, location, size, repair cost, and so forth.

The analysis facility 108 may advantageously integrate numerous independent types of damage assessment based, e.g., on separate data sets. As described above, a scan from the scanner 124 described above may include numerous, independent digital surface representations of a scanned object such as a first digital surface representation that provides surface normal data used for small dent detection in specular surfaces, a second digital surface representation of larger-scale vehicle geometry used for detecting moderate or severe vehicle damage such as substantially deformed or destroyed panels, a third digital surface representation providing two-dimensional images for, e.g., general vehicle assessment, assessment of paint damage or condition, and so forth, and any other number of digital surface representations or other digital data that might be useful for vehicle assessment.

The report 146 may thus include a damage report for a scanned vehicle based on any number of independent digital surface representations, along with vehicle identification information (e.g., a vehicle identification number, model, make, etc.), a scan of a vehicle (which may include multiple independent digital surface representations acquired using different scanning techniques), and an analysis of the scan covering, e.g., locations and sizes of defects. The report 146 may further include a diagnosis for damage, a damage assessment, a collision assessment, a repair estimate, information on third-parties (e.g., technicians, carriers, users, clients, customers, and so on), an impairment to vehicle value, and so forth, any of which may be automatically generated from the data concerning damage. Any of a variety of techniques may be used to analyze the various data sets for damage assessment including, e.g., machine vision, machine learning, artificial intelligence, expert systems, rules or heuristics, and so forth, as well as techniques for requesting manual, human intervention under certain circumstances. The report 146 may usefully document the source for any identified damage, such as by identifying the specific digital surface representation, three-dimensional location within the digital surface representation where data indicated a defect or damage, and so forth.

In one aspect, the system 100 may automatically create a repair price estimate when assessing damage, e.g., for the purpose of insurance adjustment or the like. For example, in an aspect, the report 146 is communicated to a remote resource 118 (e.g., a remote claims processing resource) over the network 102, which may in turn process the objective data in the report to calculate an estimated cost of repair using any suitable computation techniques including without limitation rules, heuristics, expert systems, machine vision, image processing, pattern matching, and so forth. In one aspect, the remote resource 118 may use multiple techniques and then integrate these estimates into a multi-factor repair estimate represented as a floor, a ceiling, a range, an average, or some other combination of the foregoing, which may be used to establish a range of acceptable bids that an insurer will reimburse for the repairs. A multi-factor repair of this manner may be particularly useful where, for example, multiple repair alternatives exist for the same damage.

In another aspect, the system 100 may distribute the report 146 for competitive bidding or similar processes. The report 146 may include a repair estimate that includes an estimate of parts and labor required for a repair, which is then communicated to one or more of the insurer platform 110, a repair provider platform 114, other service providers 116, or some other remote resource 118. In an aspect, the report 146 is transmitted to a plurality of repair provider platforms 114 for different providers over the network 102 with details of the damage including scan data, vehicle data, and so forth. The providers may, in turn, provide responsive bids for performing the repair over the network 102. In another aspect, the repair provider platform 114 may be presented with an opportunity to accept the repair job based on a price provided by the insurer platform 110. While various automated sales platforms are known in the art, the system 100 contemplated herein may usefully provide an objective damage report 146 including source scan data that can be used by recipients, either automatically or manually, to make bidding decisions.

The report 146 may include an overall number of defects or damaged areas found in the scan, which may be further categorized by area (e.g., panel), size (e.g., in relation to predetermined objects such as coins—e.g., in the U.S. market, the size of a dime, a quarter, a half-dollar, oversized, etc., or in any other suitable size bins or categories such as less than one millimeter, less than two millimeters, less than three millimeters, etc.), and severity (e.g., on a scale of 0-100 or the like representing depth, irregularity, paint damage, and so forth, or more generally representing difficulty to repair). The average size of damaged areas for each panel may then be calculated, along with the severity. Once objective damage information is produced in this manner, it becomes amenable to further automated processing. For example, this information may be used to generate an estimated replacement or repair amount for each area of a vehicle (e.g., each panel of a vehicle). The summation of these costs may be used to provide the overall estimate for the report 146. In addition, rules may be applied to select among different repair and replacement alternatives based on, e.g., parts and labor costs. In one aspect, the analysis facility 108 may include a component for assessing damage and translating the damage to a repair cost, e.g., in the report 146. This may include the most cost effective way to repair a vehicle, as well as other automatic repair cost calculations (e.g., parts prices using original equipment manufacturer (OEM) vs. reconditioned or non-OEM parts). Thus for example, where a panel has an excessive number of hail dents, it may be more expensive to repair the dents individually than to replace the entire panel, and a rule-based selection among these alternatives can be objectively applied and incorporated into the report 146.

The report 146 may also or instead include other useful information such as pictures or other images. For example, the damaged areas may be shown on a composite image sheet that includes a plurality of images of a vehicle. The images may include recommended repair methods (e.g., paintless dent repair (PDR) vs. conventional vs. partial PDR and conventional combined). The images may show each of the individual damaged areas and the dents or damage included thereon, which can be color coded or the like for type, size, severity, depth, circularity, cause (e.g., a likelihood that a dent is caused by hail or some other specific damage source), repair cost, or any other suitable criteria. The report 146 may also or instead include various views of a model created by the scan, where the report 146 usefully arranges all surface views (front, back, left, right, and top) in a single sheet.

The report 146 may include any of a variety of other visualizations from the scan. By way of example, an image of a vehicle (or a panel of a vehicle) may be displayed with individual dents identified with circles, annotations, call outs, or the like. In addition to color coding as discussed above, other visualization techniques may also or instead be employed, including z-axis amplification to show the shape of dents, arrows or the like to show the orientation of ellipses, or any other information that might be useful in quantitatively or qualitatively evaluating vehicle damage. Relief maps may be provide illustrating (and where appropriate, emphasizing or exaggerating) excursions of a measured surface from an expected surface. These types of visualizations may base comparisons on an idealized surface for a particular type of vehicle, or a comparison may be based on a prior scan or history of scans for a particular vehicle. Annotations or the like may also be provided within a display of the scan or on the report 146 showing, e.g., specific costs or ranges of costs for various areas requiring repairs, pointers to new parts (which may also be color coded), a parts list, and so forth. The report 146 or a display may also provide any suitable tools for managing a case in this context, i.e., for visually tagging approved or disapproved repairs, tagging regions for additional manual inspection, adding comments, managing workflow (e.g., scheduling repairs or other next steps), and so forth.

The report 146 may include information provided by third-parties, such as the insurer platform 110, the repair provider platform 114, or other service providers 116. In an aspect, an annotation from a technician, e.g., an annotation associated with a location within a coordinate system of the scan, is stored in the report 146. Thus, while the report 146 is generally built around an objective description of the underlying damage, the report 146 may interactively incorporate and aggregate information from a variety of users including without limitation information such as comments, information requests, annotations, corrections, highlights, adjustments, estimates, approvals, and so forth as the report 146 is used by various participants in the system 100 described herein.

More generally, the report 146 may include a status report including an objective status of a physical state of the scanned item, e.g., a scanned vehicle. Thus, the report 146 may simply document the condition of a vehicle, regardless of the presence or extent of damage, either for measuring future changes, or for accompanying other vehicle documentation in any manner that might assist in valuation, cost basis, fair market value, or the like. Such a report 146 may be associated with a vehicle and used to offer the vehicle for sale in a secondary market, or used as a condition for insuring the vehicle. The report 146 may also or instead include one or more of a vehicle mileage, a repair history, an accident history, and a visual inspection report.

In cases where the system 100 is used for the return of a vehicle at a conclusion of a vehicle lease, the report 146 may include an objective status of a physical state of the returned vehicle. Any excess damage to the returned vehicle in the report 146 that exceeds an allowance for normal wear and tear may be identified and used to adjust a value of the returned vehicle. Where damage or wear can be automatically identified and objectively characterized, e.g., based on scratches, dents, paint deterioration, missing trim, and so forth, this damage may be catalogued and used to make such an evaluation. In one aspect, the wear may be directly evaluated and compared to a baseline for physical condition of the vehicle. In another aspect, the wear may be used to estimate a value of the vehicle, which may be used for a financial comparison against a similar vehicle in good or satisfactory condition.

As discussed above, the analysis facility 108 may use one or more algorithms 144 for measurement. These algorithms 144 may apply imaging techniques selected specifically for highly specular or reflective surfaces, e.g., deflectometry or stereodeflectometry. These techniques may be adapted for capture of a complete three-dimensional model (i.e., using a three-dimensional model for polarization mode dispersion (PMD) demodulation).

Implementations may thus include virtually positioning a three-dimensional vehicle model in the system 100, and then detecting damage on the model based on measurements of surface normals with reflected light. A normalized, ideal vehicle model may be used as a baseline and the difference between this ideal vehicle model and the scanned model may be used to detect candidate damage areas. Other combinations of raw scan data, expected data (based on idealized three-dimensional models or the like), and other information may also or instead be used in the measurement algorithm 144.

More generally, any scanning technique suitable for capturing three-dimensional data, or any other surface characteristic information, from a vehicle at a level of detail that permits identification of surface defects may be usefully employed. This may include any known measurement techniques based on optics (e.g., shape from motion, shape from shade, structured light), range finding (e.g., optical or acoustic time of flight), physical contact, and so forth.

In an aspect, the processor 140 of the analysis facility 108 is configured to obtain automatic approval of the estimate 150 by a remote claim processing system (e.g., a remote claim processing system provided by the insurer platform 110 or one or more other service provider platforms 116). For example, an insurer may establish objective rules for approving a repair based on the estimated repair cost, proposed repairs, and so forth, so that an estimated repair cost can be automatically approved, provided it fits within actuarial guidelines established by the insurer. This may also include the use of processes for checking the scope of insurance (e.g., deductibles, limits, use of new and/or original manufacturer parts, and so forth), checking that insurance premiums have been paid, checking against a history of repairs for the vehicle and the driver for possible duplicative repairs or other fraud, and so forth.

The processor 140 may also or instead be configured to automatically determine whether an owner is entitled to a rental during repairs. To this end, the user interface 138 may include an interface for the owner to schedule the rental during repairs. The processor 140 may also or instead be configured to automatically process payment from an insurance carrier (via the insurer platform 110) for the repair upon verification that the repair is complete. The processor 140 may also or instead be configured to schedule a visit to an adjuster for preparation of an insurance estimate of a cost for repairing the item. The processor 140 may also or instead be configured to provide updates to the owner on the damage assessment and repair process through at least one of electronic mail, instant message, and telephone voice message, e.g., sent from the remote resource 118 to the client 106.

The insurer platform 110 may be operated by an insurance carrier or a potential insurance provider for a scanned item, e.g., a scanned vehicle. The insurance carrier may be responsible for reimbursement for a repair of the scanned item. To this end, the scan and subsequent analysis provides useful information authorizing the repair, as well as evaluating the adequacy of repairs after they have been completed. While the insurance carrier has been generally described separately from a server 122 that might be used to couple together the various participants in the system 100, the insurance carrier is a logical focal point for a damage assessment and repair process. Thus the insurance platform 110 may be integrated into the server 122 so that the insurer operates a central hub for claim processing and repair management, or the server 122 may be separately operated by an independent commercial entity.

The rental provider platform 112 may be operated by a vehicle rental service or rental car agency that uses the system 100. This may provide an interactive interface for scheduling a car rental while a vehicle is being repaired. The rental entity may also or instead use the scanning and objective damage assessment system described herein to determine whether a rented vehicle sustained damage when returned by a customer. For example, a scan of the vehicle may be provided before renting the vehicle to a customer, and a scan of the vehicle may be provided upon return of the vehicle by the customer, where the two scans are compared to assess damage to the vehicle that was sustained during the rental period. A similar procedure may be used for a leased vehicle, and as such the rental provider may include a lease provider or the like. Further, similar procedures may be used in vehicle sharing services and the like, e.g., where cars are rented for certain (typically short) periods of time.

The repair provider platform 114 may be operated by a repair service provider for items being scanned in the system 100, e.g., a vehicle repair shop or other vehicle repair professional or organization. In an aspect, the repair service provider is a commercial repair entity responsible for repairing the item being scanned, where the repair service provider reviews estimates and approves or denies work requests submitted from an insurance carrier or elsewhere in the system 100. In another aspect, the repair service provider provides an estimate for repairing a scanned item, e.g., based on the report 146. The system 100 may include a plurality of repair provider platforms 114 operated by different commercial entities and connected over the network 102. Using such a system, fixed bids for repair work may be distributed by an insurance carrier for acceptance by different repair providers, or competitive bids may be solicited from repair providers based on the report 146.

The other service provider platform 116 may be operated by any other interested party to the data 132 being created, stored, analyzed, and exchanged in the system 100. The other service provider platform 116 may be operated by a system administrator, a business owner, an associate, a user, a customer, or a proxy of the scanning system 104, or any other third party that might meaningfully participate in the system 100. The other service provider platform 116 may also or instead include without limitation, a computer system operated by a sales office (e.g., automobile sales or otherwise), a leasing company, a manufacturer (e.g., in the automobile industry), an automobile sharing company, a research or analytics team, an environmental agency or service related to the environment (e.g., resource for natural disasters or weather events), an inspection agency, an automobile service company, an automotive supplier, paintless dent repair (PDR) companies, a government agency, an auction house, and so forth. In an aspect, the other service provider platform 116 includes a second scanning system. In another aspect, the other service provider platform 116 may include a payment processing platform (e.g. for consumer payments), a banking platform (e.g., for commercial payments), or any other platform suitable for conducting financial transactions among users of the system 100.

The remote resource 118 may include the analysis facility 108 or otherwise include the functionality or components of the analysis facility 108 discussed above, or the remote resource 118 may be any other remote resource useful for damage assessment and repair functions as contemplated herein. For example, the remote resource 118 may provide replacement part cost databases, online estimating tools, and so forth that might be offered by third parties and usefully integrated into an analysis performed by the analysis facility 108. The remote resource 118 may also or instead include an infrastructure resource such as a used car pricing system, a parts ordering platform, and so forth.

For a costing system, the rules 136 may include one or more local cost estimating rules accessible through the network 102, e.g., from the database 120 or otherwise. A variety of commercial resources and guides exist for estimating the cost of vehicle repair based on observable vehicle conditions and other objective inputs. The costing system may in one aspect implement these currently available tools in computerized form for ease of use, as well as to facilitate the incorporation of resulting estimates into the report 146. The costing system may also or instead incorporate costing tools, rules, or algorithms specific to dent detection and remediation using, e.g., paintless dent repair. For example, the one or more local cost estimating rules may include a rule for determining when a defect identified in the damage report 146 can be repaired using paintless dent repair. The one or more local cost estimating rules may also or instead include a rule for comparing a cost of paintless dent repair for a vehicle panel to a cost of replacing the vehicle panel obtained from the tool 148, e.g., a remote repair cost tool. The one or more local cost estimating rules may also or instead include a rule or model for estimating the cost of physical repair of a vehicle panel. The rules 132 may also or instead include rules for imaging, analysis, pricing, estimating, repairs, and any other rules or data useful for providing services as contemplated herein. The tool 148 may include at least one remote repair cost tool accessible through the network 102, e.g., from the database 120 or otherwise. Thus, for example, the costing system may employ remote costing resources provided by third-party vendors, as well as local, proprietary costing tools, and these resources may be used in combination to identify a lowest-cost repair alternative from among a number of different repair or replacement options.

The remote resource 118 may secure an approval of an estimate 150 from an insurance carrier or a repair service provider, e.g., a commercial repair entity responsible for repairing the item. This may usefully be based on a report 146 containing detailed, objective information about the condition of a vehicle or other item requiring repair, in order to facilitate manual review by the entity receiving a request for approval, and/or to facilitate automated approval where the report 146 and the corresponding repairs are within limits established by the approving entity. The remote resource 118 may also or instead secure an approval of a repair based on the estimate 150 from an owner of the item (e.g., the user 105), which may similarly benefit from the information contained in the report 146. Also, the remote resource 118 may be configured to schedule the repair approved by the owner using a repair facility approved by an insurer carrier. This step may also usefully be integrated into a network-based workflow to provide the owner with automated or manual scheduling into available time slots for the repair facility.

In performing an analysis for repair, the remote resource 118 (or the analysis facility 108) may be configured to compare a pre-repair scan of an item to a prior scan for the item to identify a potentially duplicative repair. The remote resource 118 may also or instead be configured to verify a repair by securing a post-repair scan from a second scanning system and to compare the post-repair scan to at least one of the pre-repair scan and a prior scan of the item. It will be understood that this comparison may be performed in a number of ways. For example, the raw scan data for each digital surface representation may be aligned as necessary (e.g., into a common three-dimensional coordinate system or other normalized or aligned analytical space) and compared directly for discrepancies. This approach may be readily applied to three-dimensional models such as point clouds or polygonal meshes, and numerous techniques are known in the art for aligning and comparing different 3D models. This approach may also or instead be applied to digital surface representations in other forms, such as reflectometry data, tomography data, ray trace lengths, stereoscopic image pairs, or any other data that directly or indirectly encodes spatial information about a scanned surface. In another aspect, an analysis based on the raw scan data may be compared. For example, where hail damage or similar dents are detected, the comparison may include a comparison of the number, location, type, and severity of dents in a pre-repair and post-repair vehicle or other item.

The remote resource 118 may also or instead include a web server, processing resource, program, computer file, database, file server, e-mail server, media server, or other server, or any other computing resource or the like accessible through the network 102, as well as combinations of the foregoing.

The server 122 may host components of the system 100 such as the analysis facility 108, or other platforms and resources described herein. In general, the server 122 may integrate some or all of such services, either by implementing such services on the server 122 or providing an interface such as an application programming interface or other connector(s) or the like for coupling such services to one another in a cooperating relationship over the network 102. The server 122 may also or instead provide a graphical user interface for remote access and human interaction through client devices operated by owners, insurers, repair professionals, appraisers, administrators, and so forth. In one aspect, the server 122 may provide a network interface for the database 120, e.g., to support programmatic access by other services and platforms on the network 102, or to provide a graphical user interface 160 for access by human users at client devices such as the client 106.

In this latter aspect, there is disclosed herein a system for administering a damage assessment and repair process that includes a scanning system such as any of the scanning systems described above that might be configured to capture a pre-repair scan including a digital surface representation of a surface of an item and to distinguish a defect in the surface. The system may include a remote resource such as the server 122, which may be coupled in a communicating relationship through a data network to other system resources. The remote resource may include a processor configured (for example using computer code stored in a memory of the remote resource to perform the various process steps described herein) to administer a repair of an item. For example, the remote resource may be configured to perform the steps of preparing an estimate for repairing the item, securing an approval of the estimate, and then administering a repair of the item.

Preparing the estimate may include automatically using one or more local cost estimating rules and at least one remote repair cost tool accessible through the data network to obtain an estimate that may, for example, apply rules to minimize cost of the repair or satisfy other constraints such as insurance policy rules, guidelines, exclusions, or other limitations.

Securing the approval for the estimate may include submitting the estimate to a commercial repair entity such as an auto body repair shop or other resource responsible for repairing the item in order to secure an approval based on the estimate. In this context, the commercial repair entity may operate a computerized platform as described above for automatic approval of the estimate according to a set of approval rules. In another aspect, a representative from the commercial repair entity may review the estimate and the report 146 through the user interface 160 and make an approval decision based on any suitable guidelines. This approach may advantageously provide the detailed, objective information contained in the report 146 to the repair entity at the time the approval (either manual or automated) is requested in order to facilitate a more consistent and reliable approval process. Securing an approval of a repair based on the estimate from the owner of the item may also include presenting the user interface 160 to the owner for online approval, or securing an in-person approval or the like.

The database 120 may store information including without limitation models 128, data 132, rules 136, and so forth.

The models 128 may include currently scanned models such as any of the digital surface representations described above, previously generated models, previously scanned models, models supplied by a manufacturer, models that serve as a baseline, and so forth. The database 120 may include archives of each item that has been inputted into the system (e.g., each vehicle that has been scanned), which can be used for insurance adjustments and the like. The database 120 may include archives of all item data aggregated for statistical analysis or actuarial model refinement. The database 120 may thus save all damage profiles and other data created or retrieved by the system 100. The database 120 may include information regarding the availability of parts. The database 120 may include up-to-date cost information regarding parts and repairs. The database 120 may thus include a costs database.

In one aspect, the models 128 may include a three-dimensional model of a vehicle arranged, for example, into various vehicle parts. For example, different surface types may include paint material, plastic trim, headlights, vehicle foils, etc. Because these various surfaces might respond differently to various scanning techniques, an awareness of the location and optical properties of these different regions may be usefully incorporated into a three-dimensional model 128 for use in the scanning systems 104 contemplated herein. Similarly, properties of these regions, such as material and the like, may be included in the models 128, e.g., for use in calculating repair costs or defining a repair method. During a physical scan, an identifier such as a tag or the like may be added to various panels to assist in discriminating among various panels and parts during downstream processing.

The data 132 in the database 120 may include without limitation any data referenced herein, including insurance carrier information, adjustment report criteria and formatting, supplier information (e.g., cost of repairs and parts), three-dimensional models for makes and models of vehicles, and so forth. The rules 136 may include any cost estimating rules, insurance policy or coverage rules, damage assessment or analysis rules, approval rules for any participating entities, or any other rules or the like useful for facilitating a damage assessment and repair system as contemplated herein.

It will be appreciated that the foregoing description seeks to illustrate various participants in a damage assessment and repair management system as contemplated herein. In any practical implementation of such as system, responsibilities may overlap or be combined in various manners, so that multiple elements or functions described above may be combined into a single, integrated computing platform available on the network, or elements and functions that are described as integrated may instead be distributed in various ways over a number of different network resources. By way of non-limiting example, although the analysis facility 108 is described above as the component that generates the report 146, the report 146 may also or instead be generated by the client 106 or another participant. Similarly, all of the scanning, rating, costing, and other processing may be performed locally on a stand-alone computer, remotely on a server or other network resource, or some combination of these. All such variations that would be apparent to one of ordinary skill in the art are intended to fall within the scope of this description.

In one aspect, features such as cost estimating may be distributed among different system entities in a variety of ways. For example, numerous commercial cost estimating services are available for estimating repair costs to automobiles, and these services may be used where applicable or helpful. At the same time, where an entity (such as a paintless dent repair provider) has unique costing information or insight, this may be combined with other costing services. Thus for example, where the server 122 (or the analysis facility 108) is providing an integrating cost estimating process, the server 122 may apply on or more local cost estimating rules, in this case rules for determining when a defect such as hail damage can be repaired using paintless dent repair. Local cost estimating rules may also include proprietary rules for comparing a cost of paintless dent repair for a vehicle panel to a cost of replacing the vehicle panel obtained from the at least one remote repair cost tool. The local cost estimating rules may also include a rule for physical repair of a vehicle panel, or physical repair may be estimated with reference to a remote cost-estimating tool.

More generally, a server 122 that receives a damage report as described herein, and that is coupled in a communicating relationship with other online resources and platforms related to a repair process, may usefully provide a number of value added services that leverage information, approval processes, and capabilities of other participants in the system 100. For example, the remote resource 118 or the server 122 may be configured to compare a pre-repair scan to a prior scan for a vehicle or other item to identify a potentially duplicative repair (e.g., indicative of insurance fraud). The remote resource 118 or server 122 may also or instead be configured to schedule the repair approved by the owner using a repair facility approved by an insurer. That is, once the owner approves a repair, the server 122 may select a suitable repair facility based on, e.g., price, availability, owner preference, or any number of automatically or manually applied criteria. This scheduling information may usefully be stored by the server 122 for subsequent review and monitoring by the vehicle owner or other system participants. In another aspect, the remote resource 118 or server 122 may be configured to verify a repair by securing a post-repair scan from a second scanning system (which may be the original scanning system 104 or a similarly equipped resource) and comparing the post-repair scan to at least one of the pre-repair scan and a prior scan of the vehicle or other item. If the post-repair scan indicates that errors or omissions occurred in the process of the repair, then the repair service provider may be contacted to remedy the error, or any other suitable remedial action may be taken.

The processor 123 of the server 122 (or the processor 140 of the analysis facility 108, the remote resource 118, or any other suitable system resource) may be configured to automatically provide various supporting functions for administration of a repair process. In general, these capabilities flow from a combination of an objectively-based damage report and an integration of different platforms with network-facing tools and resources. For example, the server 122 may be configured to obtain an automatic approval of an estimate by a remote claim processing system, such as by presenting the estimate in a suitable electronic format to a rules-based claim processing engine operated by an insurance carrier or the like. In another aspect, the processor may be configured to automatically determine whether the owner of a vehicle is entitled to a rental during repairs, and the user interface may include an interface (either integrated into the user interface 160, or by referring via hyperlink or the like to a third-party resource) for the owner to schedule the rental during repairs. In another aspect, the processor may be configured to automatically process payment (e.g., through a payment processing platform) from an insurer for the repair upon verification that the repair is complete. This feature may be usefully augmented by providing concurrent payment processing capabilities for the owner of a vehicle, e.g., to permit receipt of reimbursement from the insurer, or to forward reimbursement to a repair facility, or to pay a deductible or other uninsured costs incurred by the repair service provider. In another aspect, the processor may be configured to schedule a visit to an adjuster for preparation of an insurance estimate of a cost for repairing the item. This may be performed automatically, e.g., where an owner requests available time slots or advertises availability, or through a manual scheduling process negotiated between the owner and the adjuster. In another aspect, the processor may be configured to provide updates to the owner on the damage assessment and repair process through at least one of electronic mail, instant message, telephone voice message, and updating a webpage accessible by the owner (e.g., a status page). More generally, the server 122 may provide a single, integrated interface for each step in an insurance adjusting process, including separate programmatic or human user interfaces for separate participating entities as appropriate.

While this disclosure is intended to be broad, one useful application of this system is for administration of a damage assessment and repair process for a hail-damaged vehicle. In this context, the pre-repair scan may include a digital surface representation of a surface of one or more panels, and the scanning system may more specifically be configured to distinguish and characterize hail damage in the surface as described above. Having provided an overall context for a system for vehicle damage evaluation and repair, the description now turns to an example of a computer system that may be used to implement a physical embodiment of any of the entities, facilities, and processes contemplated herein.

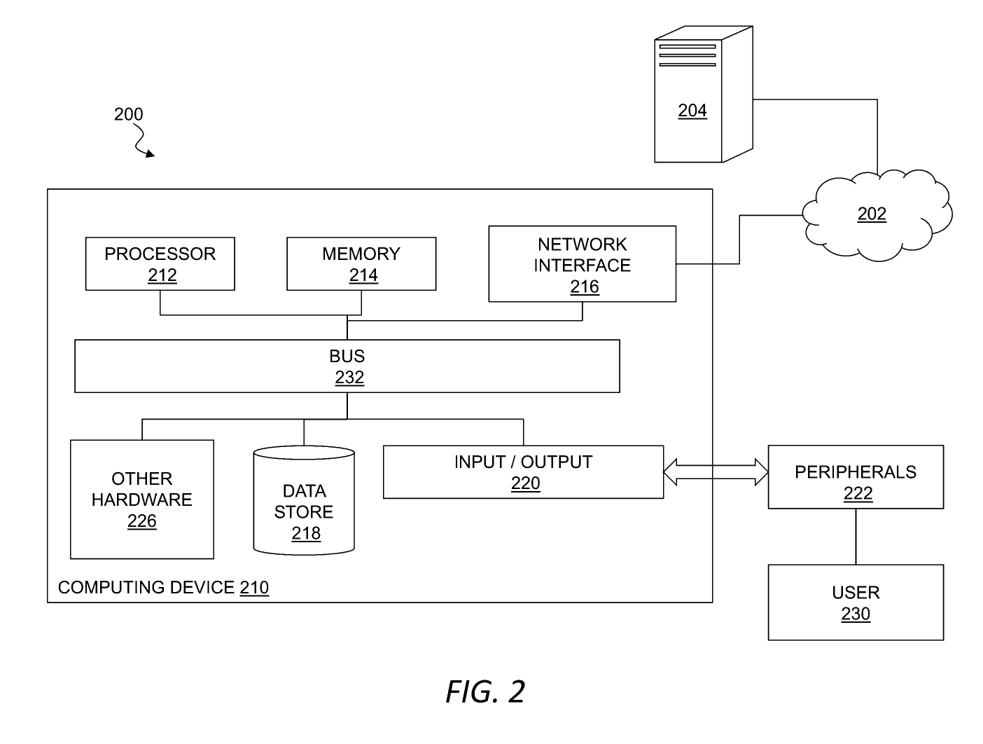

FIG. 2 illustrates a computer system. In general, the computer system 200 may include a computing device 210 connected to a network 202, e.g., through an external device 204. The computing device 210 may be or include any of the network entities described herein, e.g., with reference to FIG. 1, including data sources, servers, clients (e.g., user devices), and so forth. For example, the computing device 210 may include a desktop computer. The computing device 210 may also or instead be any device suitable for interacting with other devices over a network 202, such as a laptop computer, a personal digital assistant, a tablet, a mobile phone, a television, a set top box, a wearable computer, and the like. The computing device 210 may also or instead include a server such as any of the servers described herein. In certain aspects, the computing device 210 may be implemented using hardware, software, or a combination of software and hardware. The computing device 210 may be a standalone device, a device integrated into another entity or device, a platform distributed across multiple entities, or a virtualized device executing in a virtualization environment.

The network 202 may include any network described above, e.g., data network(s) or internetwork(s) suitable for communicating data and control information among participants in the computer system 200. This may include public networks such as the Internet, private networks, and telecommunications networks such as the Public Switched Telephone Network or cellular networks using third generation cellular technology (e.g., 3G or IMT-2000), fourth generation cellular technology (e.g., 4G, LTE. MT-Advanced, E-UTRA, etc.) or WiMax-Advanced (IEEE 802.16m)) and/or other technologies, as well as any of a variety of corporate area, metropolitan area, campus or other local area networks or enterprise networks, along with any switches, routers, hubs, gateways, and the like that might be used to carry data among participants in the computer system 200. The network 202 may also include a combination of data networks, and need not be limited to a strictly public or private network.

The external device 204 may be any computer or other remote resource that connects to the computing device 210 through the network 202. This may include any of the servers, facilities, resources, or data sources described above.

In general, the computing device 210 may include a processor 212, a memory 214, a network interface 216, a data store 218, and one or more input/output interfaces 220. The computing device 210 may further include or be in communication with peripherals 222 and other external input/output devices that might connect to the input/output interfaces 220.

The processor 212 may be any processor, group of processors, or other processing circuitry capable of processing instructions for execution within the computing device 210 or computer system 200. The processor 212 may include a single-threaded processor, a multi-threaded processor, a multi-core processor and so forth. The processor 212 may be capable of processing instructions stored in the memory 214 or the data store 218, and in this manner, the processor 212 may be configured to perform the various steps and methods contemplated herein.

The memory 214 may store information in a non-transitory form within the computing device 210. The memory 214 may include any volatile or non-volatile memory or other computer-readable medium, including without limitation a Random Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. The memory 214 may include a number of different stages and types of memory for different aspects of operation of the computing device 210. For example, a processor may include on-board memory and/or cache for faster access to certain data or instructions, and a separate, main memory or the like may be included to expand memory capacity as desired. All such memory types may be a part of the memory 214 as contemplated herein.

The memory 214 may, in general, include a computer readable medium containing non-transitory computer executable code that, when executed by the computing device 210 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down. A second memory such as a random access memory may provide volatile (but higher speed) memory for storing instructions and data for executing processes. A third memory may be used to improve performance by providing higher speed memory physically adjacent to the processor 212 for registers, caching, and so forth.

The network interface 216 may include any hardware and/or software for connecting the computing device 210 in a communicating relationship with other resources through the network 202. This may include remote resources accessible through the Internet, as well as local resources available using short range communications protocols using, e.g., physical connections (e.g., Ethernet), radio frequency communications (e.g., WiFi), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like.

More generally, the network interface 216 may include any combination of hardware and software suitable for coupling the components of the computing device 210 to other computing or communications resources through the network 202. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 202 such as the Internet. This may also or instead include hardware/software for a WiMax connection or a cellular network connection (using, e.g., CDMA, GSM, LTE, or any other suitable protocol or combination of protocols).

The data store 218 may be any internal memory store for storing data in a computer-readable medium such as a disk drive, an optical drive, a magnetic drive, a flash drive, or other device capable of providing mass storage for the computing device 210. The data store 218 may store computer readable instructions, data structures, program modules, and other data for the computing device 210 or computer system 200 in a non-volatile form for relatively long-term, persistent storage and subsequent retrieval and use. For example, the data store 218 may store an operating system, application programs, program data, databases, files, and other program modules or other software objects and the like.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for wirelessly coupling in a communicating relationship with other local devices. It will be understood that, while the network interface 216 for network communications is described separately from the input/output interface 220 for local device communications, these two interfaces may be the same, or may share functionality, such as where a USB port is used to attach to a USB-based WiFi adapter, or where an Ethernet connection is used to couple to a local network attached storage device.

A peripheral 222 may include any device used to provide information to or receive information from the computing device 200. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset, or any other audiovisual device for presenting information to a user. The peripheral 222 may also or instead include a digital signal processing device, an actuator, or other device to support control of or communication with other devices or components. Other I/O devices suitable for use as a peripheral 222 include haptic devices, three-dimensional rendering systems, augmented-reality displays, and so forth. In one aspect, the peripheral 222 may serve as the network interface 216, such as with a USB device configured to provide communications via short range (e.g., BlueTooth, WiFi, Infrared, RF, or the like) or long range (e.g., cellular data or WiMax) communications protocols. In another aspect, the peripheral 222 may augment operation of the computing device 210 with additional functions or features, such as a global positioning system (GPS) device, a security dongle, or any other device. In another aspect, the peripheral 222 may include a storage device such as a flash card, USB drive, or other solid state device, or an optical drive, a magnetic drive, a disk drive, or other device or combination of devices suitable for bulk storage. More generally, any device or combination of devices suitable for use with the computing device 200 may be used as a peripheral 222 as contemplated herein.

In one aspect, the peripherals 222 may include any of the scanning hardware and systems contemplated herein. For example, the computer system 200 may employ any number of cameras, light sources, structured light sources, and other devices that might be used to obtain accurate information about the condition of a vehicle. Using reflective techniques as described herein, the system may employ projectors on the walls of a measurement surface, along with cameras to capture surface scans of known vehicle types ranging from small compacts up to large pickup trucks and sport utility vehicles. The devices, systems, and methods herein may also or instead include information technology infrastructure such as computers to process raw scan data, evaluate surface defects, store results, generate visualizations and reports, perform repair costing and other evaluations, process claims, schedule repairs, and so forth. This may include one or more computers at a location where a vehicle is scanned, and/or one or more other servers, databases and other remote resources that might usefully support the various functions contemplated herein. This may also include physical infrastructure such as a garage, drive-in center, mobile scanning facility, or the like that might provide a permanent or temporary facility for performing scans as contemplated herein.

Other hardware 226 may be incorporated into the computing device 200 such as a co-processor, a digital signal processing system, a math co-processor, a graphics engine, a video driver, a camera, a microphone, speakers, and so forth. The other hardware 226 may also or instead include expanded input/output ports, extra memory, additional drives (e.g., a DVD drive or other accessory), and so forth.

A bus 232 or combination of busses may serve as an electromechanical backbone for interconnecting components of the computing device 200 such as the processor 212, memory 214, network interface 216, other hardware 226, data store 218, and input/output interface. As shown in the figure, each of the components of the computing device 210 may be interconnected using a system bus 232 in a communicating relationship for sharing controls, commands, data, power, and so forth. While illustrated as a single back plane, it will be appreciated that the bus 232 interconnecting components of the computing device 210 may include any number of separate busses, connectors and the like for different purposes (e.g., power, data, control) and different devices (e.g., mass storage devices, communications hardware, etc.).

Methods and systems described herein may be realized using the processor 212 of the computer system 200 to execute one or more sequences of instructions contained in the memory 214 to perform predetermined tasks. In embodiments, the computing device 210 may be deployed as a number of parallel processors synchronized to execute code together for improved performance, or the computing device 210 may be realized in a virtualized environment where software on a hypervisor or other virtualization management facility emulates components of the computing device 210 as appropriate to reproduce some or all of the functions of a hardware instantiation of the computing device 210.

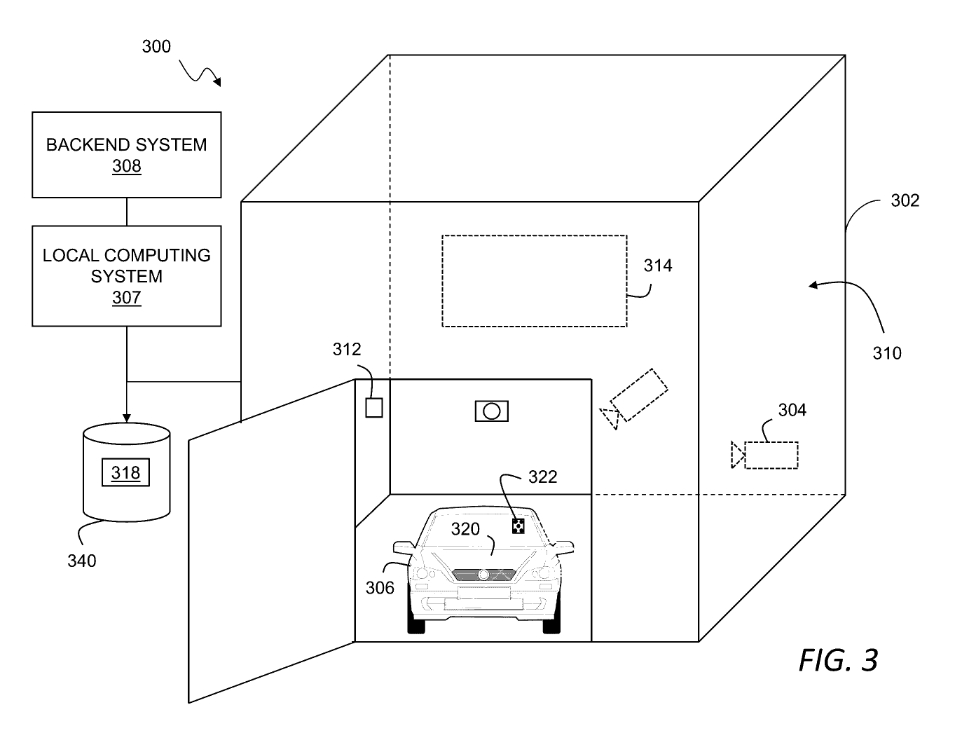

FIG. 3 illustrates a scanning system. The scanning system 300 may include a structure such as an enclosure 302, one or more imaging devices 304, and an item 306 to be scanned, where a local computing system 307 to operate the scanning system 300 may be in communication with a backend system 308 through a network or the like.

The enclosure 302 may include a booth, a bay, a garage, or the like. This may, for example, include a fixed structure such as a garage or other drive-in or drive-through facility. This may also or instead include a mobile or portable structure such as an assembly that can be unpacked into a gantry or other assembly for scanner hardware and a tent or similar temporary enclosure formed of fabric or other sheet or web material over a structural frame, or any other portable enclosure or the like for drive-through operation. In another aspect, a trailer or the like may be sized and configured to fit around a vehicle in a manner to facilitate fixed or drive-through scanning. The enclosure 302 may be configured for a user to maneuver an item 306 such as an automobile or other vehicle into and out of the enclosure 302 for scanning, and may include walls 310, one or more doors for vehicle bays, and so forth.

The walls 310, or some other structures to support scanning hardware, may include sensors 312, projectors 314 and so forth. The sensors 312 may, for example, include light sensors for detecting reflected light. The sensors 312 and projectors 314 (which may employ light emitting diodes, lasers, or other suitable light sources) may also or instead be located elsewhere in the enclosure 302.

The imaging devices 304 (e.g., digital cameras) and projectors 314 may work together to map an item 306 such as the exterior of a vehicle, to identify any defects or damage. It will be appreciated that numerous technologies are known in the art for recovering surface information from an object, including techniques using structured light, shape from motion, shape from shadow, time of flight, and so forth. All such techniques might be suitably adapted to use in a scanning and damage assessment technique as contemplated herein. This may include contact or non-contact techniques, as well as any of a variety of optical, image processing, acoustic, or other techniques for determining three-dimensional shape. One suite of techniques described above (as disclosed for example in U.S. Pat. No. 7,532,333) are particularly advantageous for use with reflective surfaces and may be suitably adapted for accurate measurement of automotive vehicle exteriors. However, any technique that can capture vehicle information in an objective, repeatable manner suitable for use with the systems and methods contemplated herein may also or instead be employed.

As discussed throughout this disclosure, the item 306 may include a vehicle. As such, the item 306 may have associated identifying information 318, such as any identifiers issued by a manufacturer (e.g., a vehicle identification number (VIN), a regulatory agency (e.g., a license plate number) or any other information suitable for uniquely identifying the item 306. Other information to identify the item 306, such as a quick response (QR) code sticker or the like may be applied to the item 306 for tracking throughout the scanning, assessment, and repair process. Any or all of this identifying information 318 may be acquired automatically, manually, or some combination of these at a location of the scanning system 300, and stored along with scan results and other inspection information for communication to the back end system 308.

The item 306 may include one or more panels 320. The panels 320 may generally include sections of an item 306, e.g., sections of a vehicle. The sections may correspond to a particular vehicle type (e.g., automobile) and classification (e.g., sedan, station wagon, sport utility vehicle, convertible, pickup truck, van, and so on). The panels 320 may include the exterior surfaces on the body of the vehicle. The panels 320 may exclude areas where no damage assessment is required, e.g., tires, wheels, bumpers, mirrors, and so forth, or where glass (i.e., windows and windshield) or other materials require alternative assessment techniques such as analysis for cracks, fractures, delamination of layered materials, or other defects. The panels 320 may include single piece panels of steel, aluminum, fiberglass, plastic or the like made by the manufacturer of the vehicle that together form the body of the vehicle.

The item 306, e.g., vehicle, may include one or more markers 322. In general, the markers 322 may include targets or the like placed in patterns on the vehicle. The markers 322 may include temporary, reusable stickers or the like (e.g., static adhesion stickers). Each marker 322 may take a variety of forms. For example, each marker 322 may include a known, predetermined pattern such as a shape or collection of shapes that can be readily detected by an optical scanner. Each marker 322 may also or instead include pseudo-random patterns that permit unique identification of each marker or group of markers. In another embodiment, a marker 322 may encode information about an item 306 (e.g. on a radio frequency identification (RFID) tag, QR code, or other scannable medium), or may encode a unique identifier for the item 306 (e.g., the marker may act as the vehicle identifier 318 discussed above). The markers 322 may be placed, for example at specific locations on a vehicle (e.g., with a lower left corner of the marker 322 aligned to a lower left corner of the right side front door), or in general locations (e.g., front windshield and back windshield), or some combination of these. In one aspect, each marker 322 might have a unique pattern that identifies a particular location on a vehicle or otherwise assists and overall scanning process. All such markers 322 might be usefully added temporarily to a vehicle during a scanning operation as contemplated herein.

The local computing system 307 may coordinate scanning of the item 306 and acquisition of related, supporting data, all of which may be locally stored in a data store 340 such as a hard drive or the like. The data acquired by the local computing system 307 may be periodically forwarded to a backend system 308 for processing as contemplated herein, such as cost estimating, repair scheduling, insurance claim processing, and so forth. The backend system 308 may, for example, include any of the servers, platforms, or resources described above with reference to FIG. 1.

In an aspect, the scanning system 300 includes six projectors (e.g., for six walls), about seventeen cameras (for optimized measurement areas based on different automobile models, i.e., covering the entire surface of different automobiles of varying sizes), surrounding walls, and a local computing system 307 with two computers implementing data processing and the like suitable for damage assessment. One skilled in the art will recognize, however, that there are other numbers and arrangements of cameras, light sources, and other scanning hardware that might be suitably be adapted for use in a scanning system 300 as contemplated herein.

The scanning system 300 may provide for the surface measurement of all relevant parts of an item 306, as well as any other suitable inspection, quality control, or the like that might usefully be performed with any of the scanning systems contemplated herein. Thus, for example, where surface measurement is one useful form of scanning, the system may also or instead, perform an optical analysis of glass surfaces for cracks, chips, fractures or other structural defects. Similarly, badging or other surface ornamentation may be inspected for visual integrity. In an aspect, the cycle time for a surface measurement scan is about five minutes, although longer or shorter scanning processes may be performed according to, e.g., the hardware capabilities of the scanning system 300, the level of detail desired for the scan, and so forth.

In addition to the identifying information 318, the data store 340 may store a wide range of information about the vehicle, the scan results, the requested repairs, and so forth. In one aspect, the local data store 340 may record information such as a damage profile, a report (such as any of the reports described herein), and images. The damage profile may include comparisons to prior scans of the vehicle (or, more generally, the item 306), which may be used for fraud prevention and detection. The damage profile may also or instead include a statistical analysis, a repair cost calculation, and a visual damage report providing a visualization of damage locations, types, sizes and so forth. Any other biographical or descriptive data may also be incorporated into the damage profile, including without limitation user annotations, vehicle identification data, owner identification data, insurance policy information, and so forth.

Comparisons for fraud prevention and detection may include comparisons to previously settled claims. This can prevent double settlement for a single repair. Other types of comparisons may also or instead be usefully performed at this stage. For example, a comparison may be made between a pre-repair and post-repair scan of a vehicle in order to ensure that repairs have been completed. This may be particularly useful, for example, as an objective verification checkpoint before an insurance company settles a claim or issues a payment to a vehicle owner or a repair shop that billed for the repair. An accurate evaluation of the condition of the surface of a vehicle has numerous other useful applications. This may, for example, include evaluating the condition of a vehicle after a rental, in order to ensure that no unidentified damage has occurred to the body of the vehicle. This may also include evaluating the condition of a vehicle after return from a long-term lease of a year or more. In this latter case, the return value of the vehicle may be assessed based on the condition of the vehicle, as compared to either or both of a baseline scan of the particular vehicle in question or to an idealized model for the make and model of vehicle.

More generally, any information necessary or useful for assessing damage, estimating repair costs, or performing needed repairs on a vehicle may be usefully incorporated into a damage profile as contemplated herein.

With objective data available from one or more vehicles, statistical analysis may also be usefully performed in a variety of different ways regardless of the particular vehicle repair process. For example, where a vehicle in a particular area is submitted for repairs of hail damage, other vehicles in the area may be reviewed to confirm that damaging hail was present in a particular area. Similarly, vehicles may be examined to obtain comparative statistics for, e.g., different makes and models of vehicles. In another aspect, long term data for a region may be used to estimate the likelihood and expected severity of hail damage events. This may be used, for example, by insurance companies in an actuarial sense to determine reasonable premiums for particular types and locations of vehicles, as well as to identify suitable actuarial factors such as whether a vehicle is typically garaged indoors.

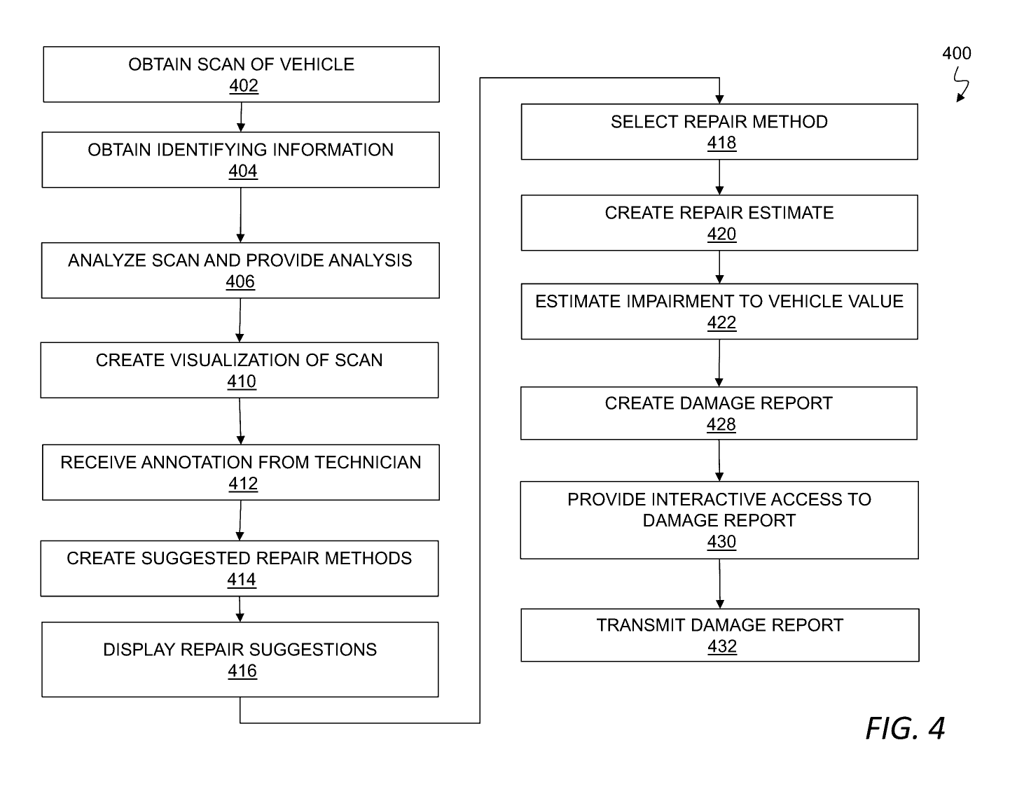

FIG. 4 illustrates a method for generating a damage report. In general, the method 400 may include linking a scan with insurance or repair related information. While the following description focuses on damage to automotive vehicles, it will be appreciated that principles of the invention may more generally be adapted to any environment where damage estimates and repair management can usefully leverage surface information from a three-dimensional scan or other digital surface representation.

As shown in step 402, the method 400 may include obtaining a scan of a vehicle. The scan may include a digital surface representation of a panel of the vehicle, such as a scan using any of the technique described above. This may include obtaining scans with a number of different scanning systems. For example, one digital surface representation may identify surface deformities such as dents caused by hail damage, while another scan may obtain a three-dimensional scan of an entire vehicle for various purposes such as identifying large-scale damage, identifying a vehicle type (and matching to other vehicle identification information as an integrity check), or locating various panels and other hardware on an exterior of the vehicle. The scan may also or instead include other types of digital data characterizing a vehicle or other item. For example, one or more two-dimensional images may be obtained, e.g., to document a vehicle condition or for analysis of surface damage, paint deterioration, and so forth. Scanning may also or instead include measurements of gross vehicle dimensions such as length, width, height, weight, and so forth.

As shown in step 404, the method 400 may include obtaining identifying information for a vehicle.

In one aspect, this may include obtaining license plate information, e.g., by capturing an image of a license plate for the vehicle. While license plate information may be provided by a vehicle owner or technician, this information may also or instead be automatically obtained in a scan by the scanning system as described above and used as a further data integrity check. For example where three-dimensional modeling of a vehicle is performed using two-dimensional images, these images may also be analyzed using optical character recognition or the like to extract license plate data. In another aspect, a single image of the front and/or back of a vehicle (or any other location where license plate information might normally be displayed) might be automatically captured when a vehicle is positioned for scanning within a booth or the like, or as a vehicle enters or exits a bay, building, or gated area where other data acquisition is performed. In another aspect, a technician may capture a digital image and forward it to an appropriate facility for processing. For example, a smart phone application or the like may be deployed so that the technician can take a picture of a license plate with a smart phone, and have this picture added to a digital record for the vehicle by transmitting the picture over a short range wireless network to the scanning system that assembles a damage report integrating various sources of vehicle information. A variety of image processing techniques are known in the art for optical character recognition, any of which might be suitably adapted to interrogate images for license plate information.

The license plate information may be compared to a vehicle identifier for the vehicle, e.g., to confirm an identity of the vehicle or an owner of the vehicle. In this manner, license plate information may be used, for example, to retrieve owner information, insurance information, or any other information such as accident reports, traffic violations, or the like that might be relevant to vehicle condition, repair history, and so forth. The license plate information may also be cross-referenced to a vehicle identification number or the like in order to cross-reference and validate any of the information above, or to retrieve a corresponding three-dimensional model for comparison to the current vehicle condition. Similarly, a variety of validation steps might be performed, such as checking an automatically captured license plate against corresponding user-supplied information, or checking the make and model of vehicle associated with the license plate against a vehicle identified in a three-dimensional scan.

Other types of checks and cross-references may also be performed. For example, the image may be analyzed to identify, e.g., an inspection sticker, registration sticker, or the like in order to insure that this information is current. A check may also or instead be performed against motor vehicle registry information. A notification to a user/owner may be usefully provided when information on the vehicle such as insurance, registration, or inspection is out of date.

In another aspect, obtaining identifying information may include obtaining a vehicle identification number, information about an owner, or information about an insurer. In another aspect, obtaining identifying information may include verifying the owner and the insurer based on a vehicle identifier such as the license plate, which permits verification with reference to motor vehicle registry data, insurer data, repair history databases or other resources.

As shown in step 406, the method 400 may include analyzing the scan to detect and to distinguish a defect in the panel. In general, this may include comparing results of the scan from step 402 with expected results. In one aspect, this may include a spatial comparison of three-dimensional data from a digital surface representation obtained during the scan to a representative three-dimensional model for the corresponding panel such as an idealized scan based on the vehicle (e.g., based on the surface shape of the panel when the vehicle is manufactured) or based on a prior scan for the particular vehicle being assessed. This may be particularly useful for relatively severe damage such as a crushed door or fender panel. However, three-dimensional scanning techniques that might be used to capture a three-dimensional model of a vehicle may not be sufficiently sensitive to small deformations caused by road debris or hail.

As noted above, surface normals are highly sensitive to small-impact dents such as hail damage, and any technique for measuring surface normals of reflective surfaces (such as any of those described herein) may be used to capture useful information on the location, size, and depth of these dents. Thus in one aspect, analyzing the scan may include evaluating surface normals for the panel to detect defects such as hail damage or similar small-impact deformations. Analyzing the scan may further include related processing such as counting, characterizing, or measuring these dents where they are detected, and providing summary data, graphical representations, and so forth.

Analyzing the scan may for example include determining whether the defect can be repaired using paintless dent repair. Analyzing the scan may also or instead include estimating a cost to repair the defect using paintless dent repair, and or comparing this cost to other costs. Paintless dent repair is a well-established technique for repairing minor dents from the body of a motor vehicle. This is commonly used for repair of hail damage and other minor dings and dents where the paint has not been cracked or otherwise compromised. This may also be used to reduce the size of a larger dent to minimize the need for filler and other treatment prior to repainting. Where paintless dent repair can adequately address the structural and aesthetic damage of a number of dents or dings, this is often preferred as a cheaper and faster alternative to either (a) filling and painting a panel, or (b) replacing a panel in its entirety. The extent of hail damage is not always clear upon human visual inspection, and as a result, visual inspection may fail to produce a consistent, reliable conclusion as to the cheapest form of repair. A digital scan using, for example, the techniques described above, significantly improves upon manual inspection processes by automating the process of dent detection for more consistent identification of damage. Scan data can also usefully characterize the diameter, depth and location of each dent so that the viability of paintless dent repair and the accompanying cost can more accurately and consistently be assessed and compared to other repair alternatives.

Thus providing an analysis as contemplated herein may include providing an analysis including a location of a defect and a size of the defect, e.g., based on the analysis of the scan that detects and distinguishes defects in the panel. The analysis may also include a suitability of paintless dent repair for addressing the defect, and an estimated cost of such repairs.

Other scanning techniques may also or instead be used, either to provide additional information for surfaces that have been scanned as described above, or to provide information for other surfaces of an item. For example, glass windows or the like may be evaluated for fracture, which can potentially manifest with little or no deformation in aggregate glass shape. In this context, the scan and resulting analysis may be based on light transmissivity rather than light reflection. More generally any combination of scanning techniques may be used to provide additional information or insights about the condition of a vehicle or other item as contemplated herein.

As shown in step 410, the method 400 may include creating a visualization of the panel that includes an image of the panel with a plurality of defects in the panel. This may, for example, include a two-dimensional or three-dimensional rendering of a panel of a vehicle, along with color-coded identification of various surface defects such as dents according to any number of defect attributes such as size (diameter, depth), severity, repair cost, cause, and so forth. Thus in one aspect there is contemplated herein a user interface that displays a panel of a vehicle along with visual highlighting of surface defects due to, e.g., hail damage, along with related information such as severity and estimated repair cost, along with a system for generating such a user interface. Numerous image processing techniques are known for identifying variations in image data and may depend for example on how the digital surface representation of the panel is encoded (e.g., polygonal mesh versus surface normal data). As such, specific techniques for automatically identifying hail damage are not discussed here in detail, and one of ordinary skill in the art would readily be able to deploy a number of different automated damage detection techniques. As noted above, techniques for detecting surface normals on a reflective surface are particularly well-suited to locating small deflections in a panel surface, and these image capture techniques may usefully be combined with suitable image processing techniques to facilitate automated detection and evaluation. In general, the resulting visualization may be incorporated into a damage report as contemplated herein.

As shown in step 412, the method 400 may include receiving an annotation from a technician. The annotation may be associated with a location within a coordinate system of the scan, e.g., a location on a panel or a vehicle. The annotation may, for example, be provided within a graphical user interface using a tool that permits the technician to select a location on a scan and then add relevant information by selecting from a menu of predetermined observations or by entering freeform text into an associated text field. The annotation may be stored, e.g., in a damage report or the like along with location information, technician commentary, owner instructions, and so forth.

As shown in step 414, the method 400 may include automatically creating a number of suggested repair methods based on a set of known repair methods stored by the system. In one aspect, this may be based on the scan described above. For body work, this will typically include three distinct options—paintless dent repair, fill and paint, or panel replacement. While paintless dent repair is typically cheaper for a small number of small-sized dents, this becomes less attractive as more and more dents are present in a panel, and the relatively fixed cost of wholesale panel replacement becomes more economically viable. Similarly, where a panel has one moderate-sized deformation rather than a number of small-sized dents, a fill and paint strategy may be the most economical. Because the scan provides an objective characterization of dent damage, an accurate estimate of repair costs can be consistently obtained for each of the three possible techniques. As noted above, multiple scan techniques may be combined for a more robust and accurate estimate. For example, a digital surface representation based on surface normals may usefully be employed to detect hail damage, while a three-dimensional point cloud or polygonal mesh may be advantageously used to detect moderate or severe panel deformations that are not suitable for paintless dent repair.

In another aspect the suggested repair methods may be based on provisions in an insurance policy. For example, a policy may provide for original manufacturer replacement parts, third party OEM parts, or refurbished parts, or some combination of these. The terms of a particular policy may automatically be retrieved by the system and applied when assessing damage in order to ensure that the final estimate accurately reflects the terms of the owner's insurance policy. In another aspect, other information such as used vehicle information may be obtained in real time so that, for example, in the case of severe damage, an accurate recommendation can be made on totaling and replacing the damaged vehicle. Other information such as whether to include the cost of a rental vehicle, may also be incorporated into the cost analysis.

As shown in step 416, the method may include displaying repair suggestions to a user. This may, for example, include presenting suggestions to an insurer, to the vehicle owner, to a repair technician, or some combination of these, so that appropriate decisions may be made for addressing a damaged item according to user preferences, insurance claim limitations and so forth. In one aspect, a vehicle owner or other user may be permitted to override a suggested repair method by paying a difference in estimated cost, or by selecting to receive cash (e.g., for the estimated repair cost or the impairment to vehicle value) in lieu of a repair. In another aspect, this step may be omitted, and a repair technique can automatically be selected and displayed to a user.

As shown in step 418, the method 400 may include selecting a repair method based on the scan. In one aspect, the repair method may be automatically selected. For example, damage such as dents or other surface defects may be evaluated initially using rules, machine learning, or other techniques to determine what types of damage are present, to determine the repair options for each defect, and then to determine a cheapest overall repair for a panel or for an entire vehicle. For example, the method 400 may incorporate a selection process where repair techniques are selected from a number of different options by taking into account whether each available technique (e.g., paintless dent removal or other repair techniques) is possible or suitable for at least a portion of the damage. In one aspect, the cost of paintless dent removal is weighed against traditional repair, and the system may automatically choose the least expensive option or provide a user with options and associated costs.

The selection may include selections from among other repair techniques such as “push to paint” techniques (i.e., push dent out, and then use paint to finish), glue pulling techniques (i.e., dents on the roof rails, e.g., can't be pushed, so a glue point is applied and the dent is pulled out), and so forth. The location of the damage may be a factor in determining what type of repair is possible. Thus, a system may use various factors (e.g., location, size, classification, etc.) to analyze the available repair options, to evaluate whether they are physically or practically possible, and to determine whether they are financially efficient. For example, the system may analyze whether the damage is disposed in a location that can be pushed or pulled, then automatically choose a repair technique and calculate a repair estimate on that basis. The above characteristics for determining a repair estimate may be based on any suitable set of objective criteria or rules.

In another aspect, the options for repair may be presented to a user such as a vehicle owner or technician. Thus, for example, one technique such as paintless dent repair may be the least expensive, but an owner may prefer to replace an entire panel and be willing to pay an expected difference in the repair cost to select this option. In this case, the user may be permitted to select a more expensive repair alternative and reimburse the insurer or repair facility for a difference in cost. In another aspect, repair options may be presented for manual selection only under certain conditions, such as when two or more different repair methods appear appropriate and relatively close in overall cost.

As shown in step 420, the method 400 may include creating a repair estimate for the vehicle. The repair estimate may be based on a repair method that has been automatically or manually selected as discussed above. The estimate may include an estimate of the total cost of performing a repair based on an estimate of parts and labor required for a repair. The cost may be calculated using local or online repair costing guidelines or tools based on available data including the vehicle scan, the selection of repair methods, and any other useful information that can be automatically obtained during the scan or manually entered by a technician or other user. The repair estimate may be added to the damage report. As described above, the repair estimate can be obtained by using, e.g., the location of the damage (e.g., on a panel), the number of damaged areas (e.g., the number of dents), the size of the damage, and the classification of the damage, as well as a selection from among different repair techniques as discussed above.

In one aspect, predictive analytics may be applied to infer damage that is not externally visible, but that is implied by an externally observable condition of the vehicle. For example, if the fender of a car is displaced by ten inches, then there are likely other parts of the vehicle that are also damaged. The externally observable physical state may be measured based on an aggregate three-dimensional scan, explicit linear measurements of a vehicle (e.g., length, width, etc.), or any other suitable scan or digital surface representation. Similarly, the system need not look behind a panel, but can predict damage based on a history of similar symptoms. This analysis may include a physical inference based on, e.g. a physical model of a vehicle or a statistical or historical inference based on data concerning similar, previous repairs resulting from a particular vehicle condition. For example, where a front end of a vehicle is deformed a certain amount, a reliable inference might be made that an internal engine part (e.g. a radiator) within the region of the deformation has been compromised. Similarly, for example, where nine out of ten vehicles with an observable external condition also have a particular internal condition requiring repair, a suitable inference can be made that the internal condition is present. More generally, any inference about internal condition(s) based on an observable external condition of the vehicle may usefully be applied to obtain more accurate estimates of the repairs that might be required to restore a vehicle to a previous state.

Predictive analytics may also or instead be used to adjust a range of possible damage so that, for example, outliers can be identified and examined in greater detail when an actual repair estimate appears too low (suggesting something was missed) or too high (suggesting excessive or fraudulent repair or claims). The predictive analysis may be based on the variance of the surface area that is damaged and a ripple zone or impact assumption can be made to encompass the related damaged area. The predictive analysis may be used for evaluating a claims process, for providing comparisons to similar vehicles and damage, to refine or fill gaps in repair pricing models, and so forth.

As shown in step 422, the method 400 may include estimating an impairment to vehicle value. The impairment to vehicle value may be included in a damage report to permit more granular consideration of whether and how to proceed with repairs, or whether the damaged vehicle is candidate for totaling and replacement. This also permits more informed consumer decisions during a repair selection process as described above, and the impairment to vehicle value may thus usefully be presented to a user earlier in the process to assist in decision making.

As shown in step 428, the method 400 may include creating a damage report. In general, the damage report may incorporate any or all of the data discussed above including, e.g., the vehicle identification information, the scan (including any number of digital surface representations or other objective data concerning vehicle condition), an analysis of damage, an estimate of the cost to repair the damage, and any other useful information. The damage report may be transmitted to a central repository maintained by the insurance agent or any other suitable party, where the damage report can operate as a live record that various entities can interact with to inform decision-making, schedule and administer corresponding repairs, receive approvals, process payments, and so forth.

As shown in step 430, the method 400 may include providing interactive access to the damage report, e.g., by the owner, the insurer, one or more repair professionals, and any other interested parties. The damage report may, for example, track approvals and repair scheduling so that a vehicle owner can monitor progress of an insurance claim. Similarly, a repair professional may commit to a repair, and the insurer may approve the repair so that all parties can track the progress of the claim and corresponding repair. More generally, any participant in the claims adjusting and repair process may interact with the damage report in order to provide updates or approvals, or to track the progress of other parties to the process.

As shown in step 432, the method 400 may include transmitting or communicating the damage report over a data network. While the damage report may be hosted at a remote resource accessible to participants over a network, the damage report may also or instead be communicated as a data structure or file to relevant parties. For example, the method 400 may include communicating the damage report to a remote claims processing resource over the data network. The method 400 may also or instead include transmitting the damage report to a plurality of repair professionals over the data network and requesting responsive bids from the repair professionals. In this manner, the method 400 may further include receiving bids from the repair professionals, and accepting or rejecting the bids. In an aspect, accepting a bid automatically creates a binding contract with a repair professional. The method 400 may also or instead include transmitting the damage report to a plurality of repair professionals over the data network and requesting acceptance of a repair based on the automatically generated repair estimate.

Using techniques described herein, i.e., with the surface condition of a vehicle accurately and objectively characterized, numerous analyses can be usefully generated, any of which may be incorporated into the damage report as contemplated herein. In an insurance/repair context, a report may identify the damage, estimate an impairment to vehicle value, estimate repair costs, indicate parts and labor required for a repair, suggest suitably qualified and approved repair shops within a geographic area, or otherwise summarize the nature of the damage and the costs and steps required for repair. In a lease or rental context, the report might include images, scans, and other data from before and after the lease (or rental) that either visually or textually describe differences between the vehicle before and after a rental/lease event. For a long term lease, the report might also automatically generate an appraisal or an impairment of value based on surface defects detected for the vehicle. For an insurance claim, the report might contain scans from before and after a repair, as well as a confirmation of completion of any scheduled repairs and/or an evaluation of the quality of the repairs. In a used vehicle context, e.g., where a vehicle is being sold to a second or subsequent owner, a report may usefully describe a surface condition of the vehicle in comparison to either or both of a new vehicle of the same type, or a vehicle of the same type and age as the used vehicle. In this latter context, the report might usefully characterize surface irregularities as within or not within a usual range of variations for a vehicle of similar age and usage (based on, e.g., mileage, engine hours, geographic region, or any other suitable criteria).

The damage report may usefully serve as a live document that is shared by various parties in a damage assessment and repair process. Thus the damage report may receive input from downstream participants—an insurer that approves an estimate, a repair shop that accepts a repair job based on the insurer-approved estimate, a vehicle owner who accepts the repaired vehicle, and so forth—and incorporate this into a complete end-to-end repair record that may be reviewed, audited, archived, and so forth. Where the damage report is hosted on a network-accessible resource, the integrity of the damage report may be maintained by the hosting entity. However, other techniques may be used to facilitate varying degrees of third-party control and ownership. For example, the damage report may also or instead be checked out of or into a data repository at the hosting facility to permit temporary use and control by a single entity. In another aspect, the damage report may by universally shared, while incorporating a sequence of cryptographic signatures or the like to ensure that any change can be reliably traced back to a particular, verifiable entity with reference to a trusted third party.

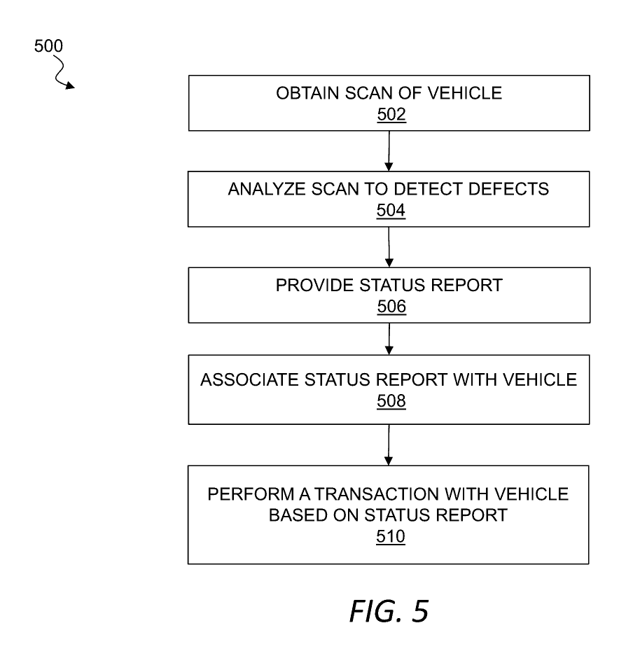

FIG. 5 illustrates a method for conducting vehicle transactions based on an objective vehicle assessment.

As shown in step 502, the method 500 may include obtaining a scan of a vehicle, where the scan includes a digital surface representation of a plurality of panels of a vehicle. The scan may be any of the scans discussed herein, and may include digital surface representations and other data from any number of different scanning techniques. While some of the scanning techniques described herein advantageously provide improved sensitivity to hail damage and similar defects, which permits accurate and objective measurement of otherwise difficult-to-detect damage, other techniques may also or instead be used to provide other objective information about vehicle condition. For example, this may include a number of linear measurements of vehicle dimensions, evaluation of glass parts for cracks or other defects, evaluation of vehicle surfaces for paint condition and deterioration, and so forth.

The scan may include one or more digital surface representations of a plurality of panels of the vehicle. As generally discussed above, the scan may capture three-dimensional surface data using at least one of optical techniques, mechanical techniques, and acoustic techniques. The scan may also or instead capture at least one of a shape and local surface normals of a surface for each one of the plurality of panels.

As shown in step 504, the method 500 may include analyzing the scan to detect defects in each one of the plurality of panels. This may, for example, include detection of hail damage or other types of vehicle damage, as well as characterization of the size, location, depth, and other features of such dents. Any other damage that can be objectively assessed based on the surface of the vehicle or other machine vision techniques or the like (e.g., to locate fractures in glass surfaces, aging of paint, and so forth) may also or instead be included in the vehicle report. Where hail damage or other surface defects are detected, the scan may be submitted for an estimate of the cost to repair the defects or an estimate of impairment to vehicle value using, e.g., any of the tools and techniques described above.

As shown in step 506, the method 500 may include providing a status report including an objective description of a physical state of the vehicle, e.g., obtained from the analysis of the scan that detects defects in each one of the plurality of panels. The status report may also or instead include other objective or subjective information. For example, the status report may include objective vehicle data such as vehicle mileage, repair history, accident history, ownership history, and so forth. The status report may also include a visual inspection report containing a subjective evaluation of the condition of the vehicle by an appraiser, technician, or other individual.

As shown in step 508, the method 500 may include associating the status report with the vehicle. This may include the creation of a vehicle status report and association of the report with the vehicle based on one or more unique vehicle identifiers such as a vehicle identification number, license plate number, or other identifying information.

As shown in step 510, the method 500 may include performing a transaction with the vehicle based on the status report. For example, this may include applying the status report as a condition for insuring the vehicle, e.g., where a potential vehicle insurer requires the status report as a condition for insuring the vehicle. This approach advantageously permits the insurer to more reliably estimate the value of the insured vehicle and work from an accurate baseline for any future repair requests presented by the insured. In another aspect, the transaction may include offering the vehicle for sale in a secondary market with the status report. This permits a seller of a used car to provide a reliable certification of the condition of the vehicle, which can also be verified by a purchaser who may request, or independently obtain, a second status report for comparison.

This also facilitates vehicle purchases that are conducted partially or wholly online by providing a reliable statement of vehicle condition for a potential purchases. In this latter use case, the status report may be created by a trusted, independent third party such as a company or other organization or entity that provides certified and objective vehicle assessments. Thus in one aspect, there is disclosed herein a certification process where an objective vehicle assessment is performed, and a status report is created and associated with a vehicle. The status report may then be digitally signed or otherwise configured to permit independent verification of the certifying entity with reference to a trusted third party such as a global certificate authority or trust authority. In another aspect, there is disclosed herein a digitally signed vehicle status report containing objective information concerning vehicle condition.

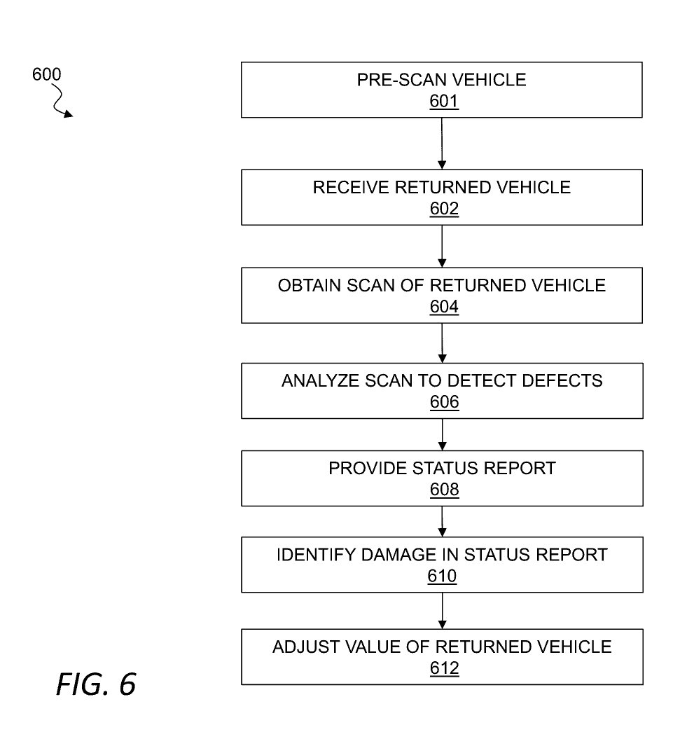

FIG. 6 shows a method for assessment of damage to a returned vehicle. As shown in FIG. 6, the objective status report described herein may provide significant advantages in managing returns from short or long term vehicle rentals such as consumer rentals or leases.

As shown in step 601, the method 600 may include pre-scanning a vehicle before a user leases or rents the vehicle using any of the scanning techniques described above. This step can usefully establish a baseline for existing damage at the time the rental is initiated.

As shown in step 602, the method 600 may include receiving a returned vehicle. The returned vehicle may be a vehicle returned at a conclusion of a vehicle lease or at a conclusion of a rental term or other rental/lease period. The vehicle lease or rental agreement may include an allowance for normal wear and tear in a physical condition of a plurality of panels of the returned vehicle at the conclusion of the vehicle lease or rental period, particularly in the case of a long term lease of one year or more. While wear and tear, or other assessments of vehicle condition, are often highly subjective, the use of objective digital surface representations facilitates the implementation of quantitative or otherwise objective benchmarks for vehicle condition based on any quantitative metric or characterization that can be derived from the digital surface representation. Regardless of the particular metrics used (and many are possible), this permits an objective comparison of the vehicle before and after the rental term.

As shown in step 604, the method 600 may include obtaining a scan of the returned vehicle. The scan may include any of the scans obtained from any of the scanning techniques described above. During a return process, a user may take a vehicle to a physical location of the scanning system, e.g., located at a dealership, return center, gas station, and so forth. To obtain the scan, a scanning system may be usefully deployed at a return station associated with the leasing or rental agency so that the scanning process can be more seamlessly integrated into the consumer's return process. The scanning system may also or instead be associated with an independent commercial entity, such that the user can drive the vehicle into the scanning system, get an analysis or appraisal, and then send the same to a rental or leasing company. As discussed herein, the analysis or appraisal may include a damage assessment based on objective scan data as well as any other pertinent information, e.g., pictures, prices, and so on. This information may also or instead be sent elsewhere, e.g., to a used vehicle sales facility, a vehicle dealership, a manufacturer, a service facility, an insurance carrier, a platform for resale of the vehicle, and so forth. For example, in an aspect, information from the scan is used as a proof of condition of a vehicle for resale.

As shown in step 606, the method 600 may include analyzing the scan to detect defects in each one of the plurality of panels.

As shown in step 608, the method 600 may include providing a status report including an objective description of a physical state of the returned vehicle, e.g., obtained through the analysis of the scan that detects defects in the panels. The status report may also include any of the other status report information contemplated herein, such as a qualitative assessment (e.g., grade, score, etc.) representing a condition of the vehicle (e.g., the external condition of the vehicle). Additionally, by opening the doors and hood, an interior assessment may also or instead be provided.

As shown in step 610, the method 600 may include automatically identifying excess damage to the returned vehicle in the status report. This may include any damage that exceeds an allowance for normal wear and tear. This may, for example, be based on a comparison of the scanned panel surfaces to an expected shape, curvature, or the like, or the identification of a number and severity of dents caused by hail or the like. More generally, any objective technique for comparing pre-scan data to post scan data to identify changes in the vehicle surface may be usefully applied to identify excess damage as contemplated herein.

As shown in step 612, the method 600 may include adjusting a value of the returned vehicle under the vehicle lease according to the excess damage. This may, for example, be based on a general condition of the vehicle, or on estimated costs of repairing the damage using, e.g., any of the cost estimating techniques described herein. In one aspect, adjusting the value of the returned vehicle may include issuing a repair bill to the party returning the vehicle. In another aspect, adjusting the value may include issuing a repair requirement, which the returning owner may present to an insurer or otherwise address for remediation.

Thus a leasing or rental company may use the scanning systems described herein for an evaluation process, where the scanning system provides an automatic, rule-based evaluation of a vehicle, an automatic determination of residual value of a vehicle, an automatic upload of vehicle information to a salvage exchange, and the like. In another aspect, a user may proactively acquire scan data and use this data to inform a decision concerning whether to repair a vehicle independently before returning it to a leasing or rental company. The report that a user receives after a scan may thus include offers from repair companies and service providers for such repairs. Thus, a report as contemplated herein may include one or more express offers from repair service providers to perform specific repairs at a specific price. A user may then evaluate the cost of such repairs and compare this to any penalties associated with returning a damaged vehicle under a lease or similar agreement.

As discussed above, the evaluation of the vehicle may take into account an acceptable, predetermined amount of wear and tear. That is, there may be a predetermined amount of damage that is normal, and the system may ignore or filter this damage when determining whether the returned vehicle conforms to lease requirements. To this end, rules for determining what is normal wear and tear and other damage may be used, and may be usefully based on objective criteria or metrics tied to one or more digital surface representations of the vehicle in the scan(s).

A leasing or rental company may have a database that keeps track of accumulated damage to a vehicle. By way of example, a rental company might not repair damage to a vehicle right away, but the rental company may have a record of when the damage occurred such that a new renter is not responsible for this preexisting damage. All such information may be used to estimate residual value, estimate responsibility for any damage that has been identified, or otherwise facilitate a fair and objective return process for rental returns, lease returns, and other used car transactions.

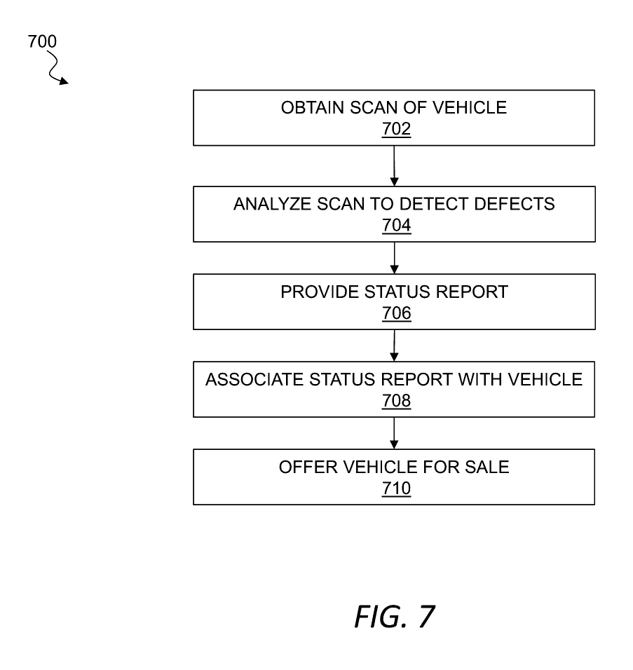

FIG. 7 illustrates a method for assessment of damage to a vehicle. The method 700 presents a non-repair use-case for scans where the report serves as a basis for valuing the vehicle rather than for administering a repair or insurance claims process. Specifically, the method 700 described below contemplates use of an objective status report in the context of offering for sale a vehicle, e.g., a used vehicle, where the value of the vehicle may be dependent upon its exterior condition. While this method is intended for use in non-repair contexts, it will be understood that estimating or requesting a repair can also or instead be included in the method 700.

As shown in step 702, the method 700 may include obtaining a scan of a vehicle. The scan may be obtained by any means as discussed herein, e.g., using a scanning system. For example, the scan may be obtained using a portable scanning system.

The scan may include a digital surface representation of a plurality of panels of the vehicle. The scan may capture three-dimensional surface data using at least one of optical techniques, mechanical techniques, and acoustic techniques. The scan may also or instead capture at least one of a shape and local surface normal of a surface for each one of the plurality of panels, or any other surface characteristic data for each one of the plurality of panels. The scan may contain three-dimensional data for some or all of the exterior of a vehicle, and may be rendered with surface irregularities highlighted with high-contrast relief or the like, e.g., as a number of indents in a rendered model.

As shown in step 704, the method 700 may include analyzing the scan to detect defects in each one of the plurality of panels. As described herein, a variety of techniques may be used to computationally extract damage information about a vehicle, such as information characterizing dents or other defects.

In general, descriptors may be generated that objectively characterize surface defects. This may include any suitable statistical descriptions or characteristics, frequency domain descriptions or characteristics, spatial characteristics, or any combination of these and/or any other transforms or other techniques that might usefully be automatically applied to identify either variations from an expected surface (e.g., an idealized three-dimensional model of a vehicle) or geometric features that appear to be dents, or a combination of these. For example, a histogram may be used for detecting damage, e.g., based on the topography of an area, and/or features may be generated using a threshold for surface curvature to locate areas of a surface where high curvature indicates a dent.

Features of one or more surfaces (e.g., from a single vehicle or from a plurality of vehicles) may be gathered for use in the creation of feature vectors that describe a surface. In an aspect, a support vector machine or other classifier or other algorithm may be trained with training data to recognize damage based on these feature vectors or other descriptors so that dent detection can be automatically performed. For example, a hail dent is generally a circle or an ellipsis, and information about the shape may correspondingly be used in the classification process. In an aspect, certain geometric features can be aggregated to reach a determination. Thus, the system may use the geometry, surface normals, or any other derived, descriptive information about a surface in order to classify surface features as dents. More generally, any objective technique for identifying unusual or unexpected surface geometry may be employed including without limitation statistical techniques, spatial frequency domain techniques, ensemble classifier techniques or any other analytical, machine learning, expert system or other techniques that can consistently detect vehicle damage in a digital surface representation of a vehicle panel.

In one aspect, keypoint generation may be used for defect detection. Keypoint generation may for example involve placing a point or other indicator on a defect that tags the point (or an area surrounding the point) as a candidate for a defect. In one aspect, this may be used to label areas for a training model or otherwise assist in creating an automated defect detection process. In another aspect, this may be used to manually label areas where defects are believed to be.

Defect detection may also include distinguishing between dents and other types of damage in a vehicle. Diameter calculations may be utilized in determining damage. For example, dents may be categorized according to size in any suitable manner based on, e.g., corresponding repair costs, general size categories, likelihood of being caused by hail, or any other quantitative or qualitative criteria that can be applied by a computer process that is automatically identifying defects as contemplated herein. A predetermined threshold for diameter may be used, for example to filter out non-dents or extremely minor defects (bordering on undetectable).

As shown in step 706, the method 700 may include providing a status report including an objective status of a physical state of the vehicle. The status report may include results from any of the analysis discussed herein. The status report may include information from the scan as well as other identifying information for the vehicle or other vehicle characteristics, history, and data. For example, the status report may include one or more of a vehicle mileage, a repair history, an accident history, an ownership history, a visual inspection report or any other information useful for a subjective or objective evaluation of a vehicle.

As shown in step 708, the method 700 may include associating the status report with the vehicle, for example, using any of the vehicle identifiers described above.

As shown in step 710, the method 700 may include offering the vehicle for sale with the status report, e.g., in a secondary market. This may, for example, include offering the vehicle for sale at a live auction, or offering the vehicle for sale using an online or paper-based listing service. The status report may be particularly useful in an online context where a potential purchaser can easily retrieve relevant, objective information about vehicle condition. As described above, this status report may usefully be digitally signed or otherwise certified by an independent third party so that the potential purchaser can verify and rely on the identity and independence of the source of the report.

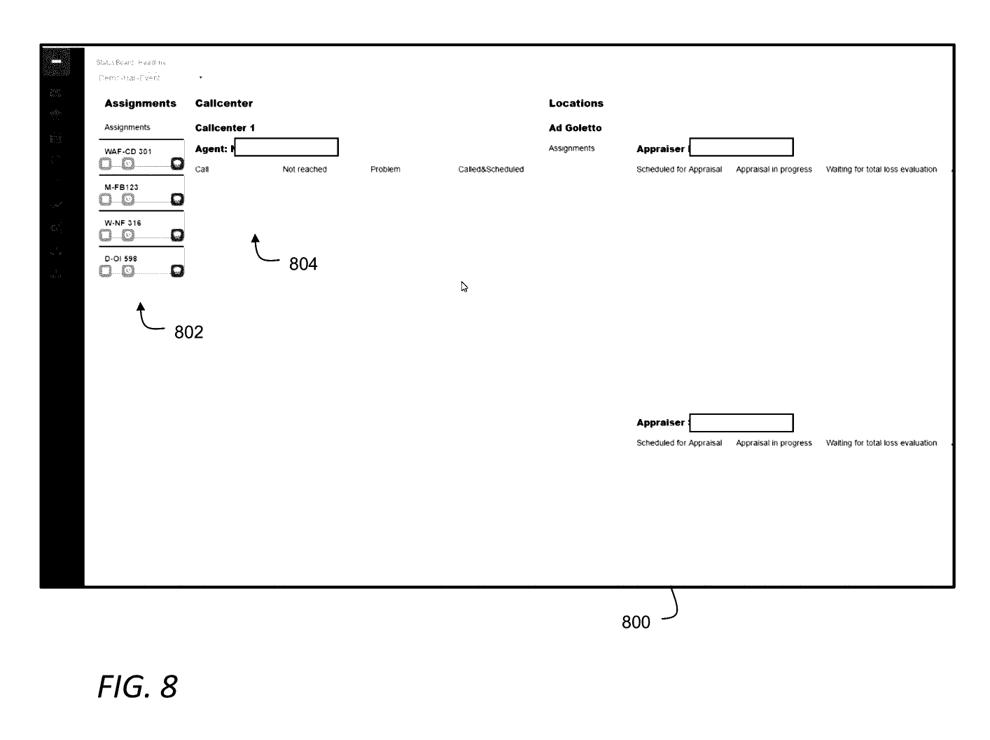

FIG. 8 shows a user interface for a damage assessment and repair administration system. While the servers described above usefully provide a programmatic interface for interconnecting resources, sharing data in databases or from scanners, and so forth as described above, a server may also usefully provide a user interface 800 such as a web-based graphical user interface for a human user to interact with the system.

The user interface 800 may be hosted by the server or any of the other resources described above. In one aspect as illustrated in FIG. 8, the user interface 800 provides a platform for case management in an insurance/repair context. In particular, a case manager, may have access to a pool of assignments 802 that have been submitted to the insurer through a customer-facing web site, call center, or other resource or combination of resources. The user interface 800 may provide the case manager with a drag-and-drop interface for assigning a case to an agent in a call center, e.g., by selecting an assignment and dragging it into the call center area 804. From here, the call center agent may access the case (e.g., through a call center user interface) and attempt to contact the insured party to further process the case. The assigned case may be visually tracked as it progresses to an adjuster, a repair facility, financial processing and so forth, with each user having an independent view of active cases according to the user's access privileges, role in the process, and so forth. By integrating various participants in the insurance process, the user interface 800 may usefully provide a comprehensive and appropriate screen to any appropriate user, or user-specific interfaces according to user roles or functions. For example, an insured party may be able to view case progress for a claim, as well as approval status, upcoming scheduled items, expected completion dates, and so forth. The call center agent may be able to view a list of currently open cases that have been assigned by a case manager. And an appraiser or adjuster may be able to view any cases scheduled for a week, as well as the status of submitted appraisals and the like.

The user interface 800 may more generally be used to administer the repair process, e.g., by permitting the insurance carrier, the vehicle owner, or a case manager to monitor progress, provide additional instructions, resolve unexpected issues, and so forth. Administering the repair may more generally include monitoring progress, providing needed instructions or approvals, providing reminders of scheduled work and due dates, and so forth. The user interface 800 may usefully provide a wide range of features to users of the system in this context. For example, the user interface 800 may include an interface for manual approval of an estimate by an insurance professional. The user interface 800 may also or instead provide customer-facing features, such as an interface for the owner to schedule a repair, an interface for providing status updates to the owner on the damage assessment and repair process, or an interface for the vehicle owner to upload data and images. The user interface 800 may also or instead provide general information to users such as contact information for an insurer that is responsible for the repair. The user interface 800 may also or instead include interactive features such as a chat interface for customers or other system users to communicate with an insurer that is responsible for the repair. More generally, any feature or function based on the various resources, data, and objective scan data may be deployed within the user interface 800 of a damage assessment and repair management system as contemplated herein.

While the foregoing describes a particular technique for computer aided assessment of vehicle damage and administering the repair of same, it will be understood that detailed vehicle geometry information may have wider applicability, and may be usefully employed to augment assessments, appraisals, insurance claims, repair scheduling, post-repair evaluations, fleet management, car sales transactions, insurance policy inception, and a wide range of other useful vehicle management processes.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
obtaining a scan of a vehicle, the scan including a digital surface representation of a panel of the vehicle;
analyzing the scan to detect and to distinguish a defect in the panel, thereby providing an analysis including a location of the defect and a size of the defect;
obtaining vehicle identification information for the vehicle including a vehicle identifier, an owner, and an insurer;
verifying the owner and the insurer based on the vehicle identifier;
combining the vehicle identification information, the scan, and the analysis into a damage report; and
communicating the damage report to a remote claims processing resource over a data network.

2. The method of claim 1 further comprising automatically selecting a repair method based on the scan.

3. The method of claim 1 further comprising automatically creating a number of suggested repair methods based on the scan, and presenting the number of suggested repair methods to a user.

4. The method of claim 1 wherein analyzing the scan includes determining whether the defect can be repaired using paintless dent repair.

5. The method of claim 1 wherein analyzing the scan includes estimating a cost to repair the defect using paintless dent repair.

6. The method of claim 1 wherein analyzing the scan includes creating a repair estimate for the vehicle.

7. The method of claim 6 further comprising adding the repair estimate to the damage report, the repair estimate including an estimate of parts and labor required for a repair.

8. The method of claim 1 wherein analyzing the scan includes estimating an impairment to vehicle value and including the impairment to vehicle value in the damage report.

9. The method of claim 1 wherein the defect includes hail damage.

10. The method of claim 1 further comprising obtaining an image of a license plate for the vehicle and comparing the license plate to the vehicle identifier.

11. The method of claim 1 further comprising creating a visualization of the panel that includes an image of the panel with a plurality of defects in the panel, the plurality of defects color coded according to one or more defect attributes.

12. The method of claim 11 wherein the one or more defect attributes include at least one of a size, a severity, a cost, and a cause.

13. The method of claim 1 further comprising receiving an annotation from a technician, the annotation associated with a location within a coordinate system of the scan, and storing the annotation in the damage report.

14. The method of claim 1 further comprising providing interactive access to the damage report by the owner, the insurer, and at least one repair professional.

15. The method of claim 1 further comprising transmitting the damage report to a plurality of repair professionals over a data network and requesting responsive bids from the repair professionals.

16. The method of claim 1 further comprising transmitting the damage report to a plurality of repair professionals over a data network and requesting acceptance of a repair based on an automatically generated repair estimate.

17. A computer program product comprising computer executable code embodied in a non-transitory computer-readable medium that, when executing on one or more computing devices, performs the steps of:
obtaining a scan of a vehicle, the scan including a digital surface representation of a panel of the vehicle;
analyzing the scan to detect and to distinguish a defect in the panel, thereby providing an analysis including a location of the defect and a size of the defect;
obtaining vehicle identification information for the vehicle including a vehicle identifier, an owner, and an insurer;
verifying the owner and the insurer based on the vehicle identifier;
combining the vehicle identification information, the scan, and the analysis into a damage report; and
communicating the damage report to a remote claims processing resource over a data network.

18. The computer program product of claim 17 further comprising code that performs the step of automatically selecting a repair method based on the scan.

19. The computer program product of claim 17 further comprising code that performs the step of automatically determining whether the defect can be repaired using paintless dent repair.

20. The computer program product of claim 17 wherein analyzing the scan includes creating a repair estimate for the vehicle.
